(19) United States
(12) Patent Application Publication
(10) Pub. No.: US 2026/0292572 A1
(43) Pub. Date: Sep. 24, 2026

(54) INTERFERENCE MEASUREMENT TIMING ADJUSTMENT

(71) Applicant: Lenovo (Singapore) Pte. Limited, Singapore (SG)

(72) Inventors: Majid Ghanbarinejad, Lake Forest, CA (US); Vijay Nangia, Woodridge, IL (US)

(73) Assignee: Lenovo (Singapore) Pte. Limited, Singapore (SG)

(21) Appl. No.: 19/474,475

(22) PCT Filed: Apr. 10, 2024
(86) PCT No.: PCT/IB2024/053509

§ 371 Date: Oct. 10, 2025

Related U.S. Application Data
(60) Provisional application No. 63/495,523, filed on Apr. 11, 2023.

(51) Int. Cl. H04W 24/10; H04B 17/318; H04B 17/345

(52) U.S. Cl. CPC H04W 24/10; H04B 17/328; H04B 17/345

(57) ABSTRACT

Various aspects of the present disclosure relate to interference measurement timing adjustment. Techniques for obtaining one or both of Tx or Rx timing offsets to be applied by an aggressor user equipment (UE) or a victim UE. The techniques work based on various combinations of inter-network entity (e.g., inter-base station (BS)) signaling, configuration of timing offsets based on locations or approximate locations of devices (e.g., UEs), and so forth. In one or more implementations, a cross-link interference (CLI) report from the victim UE is obtained by applying multiple timing offsets from which the serving network entity (e.g., BS) can select a CLI value based on additional information about the aggressor UE.

### RELATED APPLICATION

This application claims priority to U.S. Patent Application Ser. No. 63/495,523 filed Apr. 11, 2023 entitled “INTERFERENCE MEASUREMENT TIMING ADJUSTMENT,” the disclosure of which is incorporated by reference herein in its entirety.

### TECHNICAL FIELD

The present disclosure relates to wireless communications, and more specifically to adjusting interference measurement timing.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In wireless communications systems, various data and control information can be communicated from one device to another, such as from a UE to a base station (e.g., a gNB) or from a base station (e.g., a gNB) to a UE. Given the various network communication devices and user communication devices in a wireless communication system and their proximity to one another, situations can arise where these devices interfere with one another when communicating data or control information.

### SUMMARY

The present disclosure relates to methods, apparatuses, and systems that support interference measurement timing adjustment. In one or more implementations, a UE receives, from a network entity, a configuration of a cross-link interference (CLI) reporting that indicates one or more resources for CLI measurements. The UE obtains a timing offset and applies the timing offset while performing a CLI measurement on the one or more resources. Additionally or alternatively, a UE receives, from a network entity, a sounding reference signal (SRS) configuration for a CLI measurement. The UE also receives, from the network entity, a second signaling indicating a timing offset to apply when transmitting the SRS, and applies the timing offset while transmitting the SRS. By using the timing offset, a UE performing CLI measurements knows more accurately when to expect to receive the SRS.

Some implementations of the method and apparatuses described herein may further include to: receive, from a network entity, a first signaling indicating a configuration of a CLI reporting that indicates one or more resources for CLI measurements; obtain a timing offset to apply when performing the CLI measurements; apply, while performing a CLI measurement on the one or more resources, the timing offset with respect to a reference point in time; transmit, to the network entity, a second signaling indicating a CLI report that includes a result of the CLI measurement.

In some implementations of the method and apparatuses described herein, the reference point is a reception time of a synchronization signal block (SSB) from the network entity. Additionally or alternatively, the result of the CLI measurement is a SRS reference signal received power (SRS-RSRP) or a CLI received signal strength indicator (CLI-RSSI). Additionally or alternatively, the method and apparatuses obtain an estimate of a location of the apparatus; and for each resource in the one or more resources: determine a location region associated with the resource; compute a distance between the estimate and the location region; and compute the timing offset based on the distance. Additionally or alternatively, the method and apparatuses receive, from the network entity in response to the apparatus leaving a location region, a third signaling indicating a new timing offset or unconfiguring the CLI reporting. Additionally or alternatively, the timing offset is determined based on whether the apparatus is located in a location region, and the location region is indicated by one or more of center coordinates, a radius, or vertices of a polygon. Additionally or alternatively, the method and apparatuses, in response to the apparatus leaving a location region: obtain an estimate of a location of the apparatus; and compute, based on the location, a new timing offset to apply while performing the CLI measurement. Additionally or alternatively, to obtain the timing offset is to receive, from the network entity, a third signaling indicating multiple timing offsets, and method and apparatuses: apply the multiple timing offsets when performing the CLI measurements on the one or more resources; obtain multiple CLI measurement results associated with the multiple timing offsets, wherein the CLI report is based on the multiple CLI measurement results. Additionally or alternatively, the CLI report comprises a CLI value equal to a maximum CLI measurement result of the multiple CLI measurement results. Additionally or alternatively, the CLI report comprises a CLI value equal to a minimum CLI measurement result of the multiple CLI measurement results. Additionally or alternatively, the CLI report comprises a CLI value equal to an average or a weighted average of the multiple CLI measurement results. Additionally or alternatively, the CLI report comprises the multiple CLI measurement results. Additionally or alternatively, the CLI report comprises a subset of the multiple CLI measurement results. Additionally or alternatively, the subset of the multiple CLI measurement results comprises a number of largest CLI measurement results of the multiple CLI measurement results. Additionally or alternatively, the subset comprises a number of smallest CLI measurement results of the multiple CLI measurement results. Additionally or alternatively, each of the CLI measurement results in the subset is an average or a weighted average of one or more of the multiple CLI measurement results. Additionally or alternatively, each of the multiple CLI measurement results is a SRS-RSRP or a CLI-RSSI. Additionally or alternatively, the method and apparatuses apply the timing offset for as long as a countdown expiration timer associated with the timing offset has not reached zero. Additionally or alternatively, the method and apparatuses apply the timing offset for a validity duration associated with the timing offset. Additionally or alternatively, the apparatus comprises a UE.

Some implementations of the method and apparatuses described herein may further include to: receive, from a network entity, a first signaling indicating a SRS configuration for a CLI measurement; receive, from the network entity, a second signaling indicating a timing offset to apply when transmitting the SRS; apply, while transmitting the SRS, the timing offset.

In some implementations of the method and apparatuses described herein, to apply the timing offset is to apply the timing offset with respect to a reference point in time. Additionally or alternatively, the reference point comprises an uplink transmission time according to an indicated timing advance (TA). Additionally or alternatively, the reference point comprises a reception time of a synchronization SSB from a network entity. Additionally or alternatively, the method and apparatuses: obtain an estimate of a location of the apparatus; determine a location region based on the estimate; determine one or more resources associated with the location region; and transmit the SRS, according to the SRS configuration for the CLI measurement, on the one or more resources. Additionally or alternatively, the timing offset is associated with a location region and method and apparatuses: obtain an estimate of a location of the apparatus; and apply, in response to determining that the location of the apparatus is within the location region, the timing offset while transmitting the SRS. Additionally or alternatively, the method and apparatuses receive, from the network entity in response to the apparatus leaving a location region, a third signaling indicating a new timing offset or unconfiguring CLI reporting. Additionally or alternatively, the timing offset is determined based on whether the apparatus is located in a location region, and the location region is indicated by one or more of center coordinates, a radius, or vertices of a polygon. Additionally or alternatively, the method and apparatuses, in response to the apparatus leaving a location region: obtain an estimate of a location of the apparatus; and compute, based on the location, a new timing offset to apply while performing the CLI measurement. Additionally or alternatively, the method and apparatuses: receive, from the network entity, a third signaling indicating a configuration for a reference signal, wherein the reference signal comprises a synchronization signal sequence, a synchronization signal identifier, or a phase rotation; and transmit, to a UE, a fourth signaling in accordance with the configuration for the reference signal. Additionally or alternatively, the method and apparatuses apply the timing offset for as long as a countdown expiration timer associated with the timing offset has not reached zero. Additionally or alternatively, the method and apparatuses apply the timing offset for a validity duration associated with the timing offset. Additionally or alternatively, the apparatus comprises a UE.

Some implementations of the method and apparatuses described herein may further include to: receive, from a first network entity, a first signaling indicating a configuration of one or more resources for a CLI measurement; transmit, to a UE, a second signaling indicating a configuration of a CLI reporting that indicates the one or more resources and a timing offset for the UE to apply when performing the CLI measurements; and receive, from the UE, a third signaling indicating a CLI report including a result of the CLI measurements.

In some implementations of the method and apparatuses described herein, the method and apparatuses obtain the timing offset based on one or both of parameters or propagation delays by exchanging information regarding at least one of: a location of the UE or a location of an aggressor UE, a TA of the UE or a TA of the aggressor UE, or a location of the apparatus or a location of the network entity. Additionally or alternatively, the method and apparatuses receive, from the first network entity, a fourth signaling indicating the timing offset, wherein the fourth signaling comprises a backhaul signaling or an over-the-air (OTA) signaling, wherein the timing offset is based on at least one of: a location of the network entity location obtained via a global positioning system (GPS), a global navigation satellite system (GNSS), or an operations, administration, and management (OAM); a location of the apparatus obtained via GPS or GNSS and shared with the network entity or via OAM; an approximate location of an aggressor UE obtained by a TA based location estimation at the network entity; or an approximate location of the UE obtained based on knowledge that the UE is located at a cell edge of the apparatus or that the apparatus has a small cell coverage area. Additionally or alternatively, the method and apparatuses obtain an estimate of the timing offset based on at least one of: a location of the apparatus obtained via a GPS, a GNSS, or an OAM; a location of the network entity obtained by the network entity via GPS or GNSS and shared with the apparatus or via OAM; an approximate location of the UE obtained by a TA based location estimation at the apparatus; or an approximate location of an aggressor UE obtained based on knowledge that the aggressor UE is located at a cell edge of the network entity or that the network entity has a small cell coverage area. Additionally or alternatively, the method and apparatuses obtain an estimate of the timing offset based on at least one of: a location of the apparatus; a location of the network entity; an approximate location of the UE; or an approximate location of an aggressor UE obtained by the network entity and indicated to the network entity via a backhaul signaling or an OTA signaling. Additionally or alternatively, the results of the CLI measurements are a SRS-RSRP or a CLI-RSSI. Additionally or alternatively, the method and apparatuses transmit, to the UE in response to the UE leaving a location region, a fourth signaling indicating a new timing offset or unconfiguring the CLI reporting. Additionally or alternatively, the timing offset is determined based on whether the UE is located in a location region, and the location region is indicated by one or more of center coordinates, a radius, or vertices of a polygon. Additionally or alternatively, the method and apparatuses transmit, to the UE, a fourth signaling indicating that the UE is to apply the timing offset for as long as a countdown expiration timer associated with the timing offset has not reached zero. Additionally or alternatively, the method and apparatuses transmit, to the UE, a fourth signaling indicating that the UE is to apply the timing offset for a validity duration associated with the timing offset. Additionally or alternatively, the apparatus comprises a base station or a next-generation radio access network (NG-RAN) node.

Some implementations of the method and apparatuses described herein may further include to: transmit, to a UE, a first signaling indicating a configuration of a SRS for a CLI measurement, wherein the configuration indicates one or more resources each of which is associated with one of multiple location regions; and transmit, to a network entity, a second signaling indicating the configuration.

In some implementations of the method and apparatuses described herein, the method and apparatuses transmit, to the UE, a third signaling indicating a timing offset for the UE to apply when transmitting the SRS. Additionally or alternatively, the method and apparatuses obtain the timing offset based on one or both of parameters or propagation delays by exchanging information regarding at least one of: a location of the UE or a location of a victim UE, a TA of the UE or a TA of the victim UE, or a location of the apparatus or a location of the network entity. Additionally or alternatively, the method and apparatuses receive, from the first network entity, a third signaling indicating the timing offset, wherein the third signaling comprises a backhaul signaling or an OTA signaling, wherein the timing offset is based on at least one of: a location of the apparatus obtained via a GPS, a GNSS, or an OAM; a location of the apparatus obtained via GPS or GNSS and shared with the network entity or via OAM; an approximate location of a victim UE obtained by a TA based location estimation at the network entity; or an approximate location of the UE obtained based on knowledge that the UE is located at a cell edge of the apparatus or that the apparatus has a small cell coverage area. Additionally or alternatively, the method and apparatuses obtain an estimate of the timing offset based on at least one of: a location of the apparatus obtained via a GPS, a GNSS, or an OAM; a location of the network entity obtained by the network entity via GPS or GNSS and shared with the apparatus or via OAM; an approximate location of the UE obtained by a TA based location estimation at the apparatus; or an approximate location of a victim UE obtained based on knowledge that the victim UE is located at a cell edge of the network entity or that the network entity has a small cell coverage area. Additionally or alternatively, the method and apparatuses obtain an estimate of the timing offset based on at least one of: a location of the apparatus; a location of the network entity; an approximate location of the UE; or an approximate location of a victim UE obtained by the network entity and indicated to the network entity via a backhaul signaling or an OTA signaling. Additionally or alternatively, the method and apparatuses transmit, to the UE, a third signaling indicating a timing offset associated with one location region of the multiple location regions for the UE to apply when transmitting the SRS while located in the location region. Additionally or alternatively, the method and apparatuses transmit, to the UE in response to the UE leaving the one location region, a fourth signaling indicating a new timing offset or unconfiguring CLI reporting. Additionally or alternatively, the one location region is indicated by one or more of center coordinates, a radius, or vertices of a polygon. Additionally or alternatively, the apparatus comprises a base station or a NG-RAN node.

### BRIEF DESCRIPTION OF THE DRAWINGS

FIG. 1 illustrates an example of a wireless communications system that supports interference measurement timing adjustment in accordance with aspects of the present disclosure.

FIG. 2 illustrates an example of intra-cell and inter-cell inter-UE CLI that supports interference measurement timing adjustment in accordance with aspects of the present disclosure.

FIG. 3 illustrates an example of inter-cell inter-UE CLI that supports interference measurement timing adjustment in accordance with aspects of the present disclosure.

FIG. 4 illustrates an example of a timeline for applying an SRS receive (Rx) offset that supports interference measurement timing adjustment in accordance with aspects of the present disclosure.

FIG. 5 illustrates an example of timing offset regions that supports interference measurement timing adjustment in accordance with aspects of the present disclosure.

FIG. 6 illustrates an example of a timeline for applying an SRS transmit (Tx) offset that supports interference measurement timing adjustment in accordance with aspects of the present disclosure.

FIG. 7 illustrates an example of timing offset regions that supports interference measurement timing adjustment in accordance with aspects of the present disclosure.

FIG. 8 illustrates an example of a UE positioning architecture that supports interference measurement timing adjustment in accordance with aspects of the present disclosure.

FIGS. 9 and 10 illustrate examples of block diagrams of devices that support interference measurement timing adjustment in accordance with aspects of the present disclosure.

FIGS. 11 through 22 illustrate flowcharts of methods that support interference measurement timing adjustment in accordance with aspects of the present disclosure.

### DETAILED DESCRIPTION

In wireless communication systems, time division duplexing (TDD) refers to the scheme of splitting radio resources among downlinks and uplinks in the time domain. In a TDD system, at any point in time in a given frequency, the base station transmits signals to one or more subscriber devices or vice versa, but typically not both. In conventional cellular systems that employ static TDD, patterns of TDD are fully synchronized and typically identical so as to avoid interference from one network entity (e.g., base station) when transmitting in a downlink to another network entity (e.g., base station) when receiving in an uplink of a nearby cell. However, if dynamic TDD is employed, where different TDD patterns may be used in different cells, the interference from one UE to another may occur, which degrades performance if not addressed by proper inter-UE interference management techniques.

Also in wireless communications system, subband full-duplex (SBFD) refers to the scheme where one or more UEs are configured to transmit uplink signals in a subband on downlink symbols, or vice versa. The one or more UEs may not be expected to have full-duplex capability on the subband, but the network entity (e.g., base station) may support duplexing for communications on the subband.

When dynamic TDD or SBFD are used in a cell, especially with beamforming at millimeter-wave frequencies, interference caused by one UE (referred to as an aggressor UE) on another UE (referred to as a victim UE) may be significant depending on the beamforming configurations at the aggressor UE and the victim UE. For example, if an aggressor UE happens to transmit an uplink signal with a transmit (Tx) beam that is spatially directed toward the victim UE, and the victim UE happens to receive a downlink signal on the same time-frequency resources with a receive (Rx) beam spatially directed toward the aggressor UE, the uplink signal may cause an excessive interference on the downlink signal. This interference may be avoided by signaling and coordination among UEs.

Discussed herein are various techniques for obtaining one or both of Tx or Rx timing offsets to be applied by the aggressor UE or the victim UE. The techniques work based on various combinations of inter-network entity (e.g., inter-base station (BS)) signaling, configuration of timing offsets based on locations or approximate locations of devices (e.g., UEs), and so forth. In one or more implementations, a CLI report from the victim UE is obtained by applying multiple timing offsets from which the serving network entity (e.g., BS) can select a CLI value based on additional information about the aggressor UE.

A reference signal, such as SRS, may be transmitted by the aggressor UE and a CLI measurement taken by the victim UE. Techniques for accurately measuring inter-UE CLI are not addressed in existing CLI frameworks. However, using the techniques discussed herein, Tx or Rx timing offsets for the reference signal are configured for the aggressor UE or the victim UE, allowing the victim UE to know when to expect to receive the reference signal and thus more accurately measure CLI between the aggressor UE and the victim UE.

Aspects of the present disclosure are described in the context of a wireless communications system. Aspects of the present disclosure are further illustrated and described with reference to device diagrams and flowcharts.

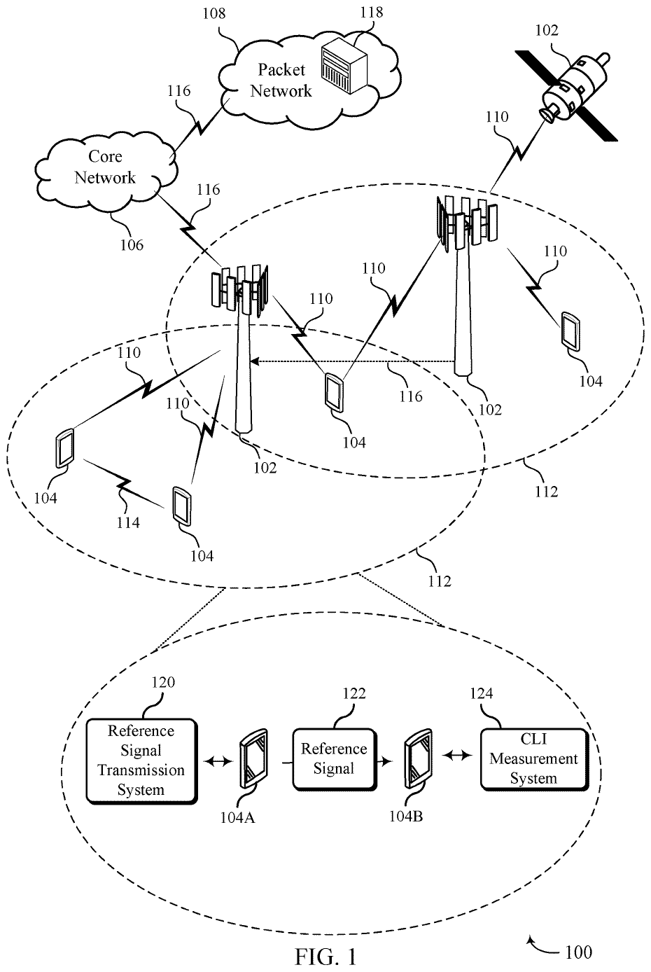

FIG. 1 illustrates an example of a wireless communications system 100 that supports interference measurement timing adjustment in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N6, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), a user plane function (UPF)), or a location management function (LMF), which is a control plane entity that manages location services. In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N6, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communication system 100 (e.g., time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix. A sixth numerology (e.g., μ=5) may be associated with a sixth subcarrier spacing (e.g., 480 kHz) and a normal cyclic prefix. A seventh numerology (e.g., μ=6) may be associated with a sixth subcarrier spacing (e.g., 960 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHz), FR3 (7.125 GHZ-24.25 GHz), FR4 (52.6 GHZ-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In one or more implementations, a UE 104 (illustrated as UE 104A) includes a reference signal transmission system 120. The UE 104A receives a reference signal (e.g., SRS) configuration from a network entity 102 serving the UE 104A. The reference signal transmission system 120 transmits a reference signal 122 that is received by another UE 104 (illustrated as UE 104B). The UE 104B includes a CLI measurement system 124 that generates a CLI measurement result based on the reference signal 122 and transmits a CLI report that includes the CLI measurement result to a network entity 102 serving the UE 104B. One or both of the reference signal transmission system 120 or the CLI measurement system 124 is configured (e.g., by their respective serving network entity 102) with a timing offset to be used when transmitting the reference signal 122 or receiving the reference signal 122.

Communication between devices discussed herein, such as between UEs 104 and network entities 102, is performed using any of a variety of different signaling. For example, such signaling can be any of various messages, requests, or responses, such as triggering messages, configuration messages, and so forth. By way of another example, such signaling can be any of various signaling mediums or protocols over which messages are conveyed, such as any combination of radio resource control (RRC), downlink control information (DCI), uplink control information (UCI), sidelink control information (SCI), medium access control element (MAC-CE), sidelink positioning protocol (SLPP), PC5 radio resource control (PC5-RRC) and so forth.

Communication between devices discussed herein, such as between UEs 104 and network entities 102, is performed using any of a variety of different signaling. For example, such signaling can be any of various messages, requests, or responses, such as triggering messages, configuration messages, and so forth. By way of another example, such signaling can be any of various signaling mediums or protocols over which messages are conveyed, such as any combination of radio resource control (RRC), downlink control information (DCI), uplink control information (UCI), sidelink control information (SCI), medium access control element (MAC-CE), sidelink positioning protocol (SLPP), PC5 radio resource control (PC5-RRC) and so forth.

Time division duplex (TDD) can be used in new radio (NR) deployments. In TDD, the time domain resource is split between downlink and uplink. Allocation of a limited time duration for the uplink in TDD results in reduced coverage, increased latency and reduced capacity. An enhancement on this limitation of the conventional TDD operation is allowing the simultaneous existence of downlink and uplink, also referred to as full duplex, for example, subband non-overlapping full duplex at the network entity (e.g., gNB) side within a conventional TDD band.

NR TDD allows the dynamic or flexible allocation of downlink and uplink in time and CLI handling and remote interference management (RIM) for NR. The techniques discussed herein also take into account CLI handling between the network entities (e.g., gNBs) of the same or different operators to enable the dynamic or flexible TDD in wireless networks. The inter-network entity (e.g., inter-gNB) CLI may be due to adjacent-channel CLI or co-channel-CLI, or both, depending on the deployment scenario. CLI may also be network entity to network entity (e.g., gNB-to-gNB) CLI.

Duplex evolution in the areas discussed above provide enhanced uplink (UL) coverage, reduced latency, improved system capacity, and improved configuration flexibility for NR TDD operations in unpaired spectrum. In one or more implementations,

In one or more implementations, supporting duplex evolution for NR TDD in unpaired spectrum is discussed herein.

In one or more implementations, the techniques discussed herein assume duplex enhancement at the network entity (e.g., gNB) side. Additionally or alternatively, the techniques discussed herein assume half duplex operation at the UE side. Additionally or alternatively, techniques discussed herein assume no restriction on frequency ranges.

One or more implementations take into consideration at least one of: applicable and relevant deployment scenarios; an evaluation methodology for duplex enhancement; the subband non-overlapping full duplex and potential enhancements on dynamic or flexible TDD; possible schemes and their feasibility and performances; inter-network entity (e.g., inter-gNB) and inter-UE CLI handling and solutions to manage the CLI; intra-subband CLI and inter-subband CLI in cases of the subband non-overlapping full duplex; or the performance of the identified schemes as well as the impact on legacy operation assuming their co-existence in co-channel and adjacent channels.

One issue identified for CLI measurements, such as in the case of inter-UE CLI measurements, is how to acquire the timing of receiving reference signal from the aggressor UE at the victim UE. If the victim UE does not acquire this information, it can affect CLI measurement accuracy, which can lead to a high packet error rate (if CLI is underestimated), or resource underutilization and unnecessary scheduling constraints (if CLI is overestimated).

In one or more implementations, enhancement to at least one of dynamic TDD, flexible TDD, or SBFD is taken into consideration. The followings are examples of enhancement methods of network entity-to-network entity (e.g., gNB-to-gNB) CLI handling that may be taken into consideration: network entity-to-network entity (e.g., gNB-to-gNB) CLI measurement and reporting; coordinated scheduling; spatial domain enhancements; advanced receiver; UE and network entity (e.g., gNB) transmission and reception timing; power control based solution; RIM; sensing based mechanism; whether a particular scheme requires OTA or backhaul information exchange; other schemes for inter-network entity (e.g., inter-gNB) CLI handling.

The followings are examples of enhancement methods of UE-to-UE CLI handling that may be taken into consideration: potential enhancements to UE-to-UE CLI measurement or reporting; coordinated scheduling; spatial domain enhancements; advanced receiver; UE and network entity (e.g., gNB) transmission and reception timing; a power control based solution; a sensing based mechanism; whether a particular scheme requires OTA or backhaul information exchange; other schemes for UE-to-UE CLI handling.

The techniques discussed herein address the matter of timing acquisition and adjustment for CLI measurements. Although various methods are described with emphasis on inter-UE CLI measurements, the methods are applicable to measuring other types of interference such as inter-network entity (e.g., inter-gNB) CLI. The techniques discussed herein span signaling and behavior at various RAN layers-L1, L2/MAC, L3/RRC, and backhaul or OTA signaling among network nodes (e.g., network entities).

When different TDD downlink (DL) or uplink (UL) patterns are used between neighboring cells, UL transmission in one cell may interfere with DL reception in another cell: this is referred to as cross link interference (CLI). To mitigate CLI, network entities (e.g., gNBs) can exchange and coordinate their intended TDD DL-UL configurations over Xn and F1 interfaces, and the victim UEs can be configured to perform CLI measurements. Two types of CLI measurements are a SRS-RSRP measurement in which the UE measures SRS-RSRP over SRS resources of one or more aggressor UEs, and a CLI-RSSI measurement in which the UE measures the total received power observed over RSSI resources. Layer 3 filtering applies to CLI measurement results and both event triggered and periodic reporting are supported.

SRS reference signal received power (SRS-RSRP) is defined as linear average of the power contributions (e.g., in [W]) of the resource elements carrying sounding reference signals (SRS). SRS-RSRP may be measured over the configured resource elements within the considered measurement frequency bandwidth in the configured measurement time occasions. For frequency range 1, the reference point for the SRS-RSRP may be the antenna connector of the UE. For frequency range 2, SRS-RSRP may be measured based on the combined signal from antenna elements corresponding to a given receiver branch. For frequency range 1 and 2, if receiver diversity is in use by the UE, the reported SRS-RSRP value may not be lower than the corresponding SRS-RSRP of any of the individual receiver branches. SRS-RSRP may be applicable for RRC_CONNECTED intra-frequency.

CLI Received Signal Strength Indicator (CLI-RSSI), is defined as linear average of the total received power (e.g., in [W]) observed only in the configured OFDM symbols of the configured measurement time resource(s), in the configured measurement bandwidth from all sources, including co-channel serving and non-serving cells, adjacent channel interference, thermal noise, etc. For frequency range 1, the reference point for the RSSI may be the antenna connector of the UE. For frequency range 2, CLI-RSSI may be measured based on the combined signal from antenna elements corresponding to a given receiver branch. For frequency range 1 and 2, if receiver diversity is in use by the UE, the reported CLI-RSSI value may not be lower than the corresponding CLI-RSSI of any of the individual receiver branches. CLI-RSSI may be applicable for RRC_CONNECTED intra-frequency.

FIG. 2 illustrates an example 200 of intra-cell and inter-cell inter-UE CLI that supports interference measurement timing adjustment in accordance with aspects of the present disclosure. The example 200 is an example scenario where UEs served by two cells in a vicinity may cause CLI. Depending on whether the aggressor UE and the victim UE are in the same cell or in different cells, the inter-UE CLI may be called intra-cell or inter-cell, respectively. Intra cell inter-UE CLI is illustrated with dashed arrowed lines and inter-cell inter-UE CLI is illustrated with solid dashed lines.

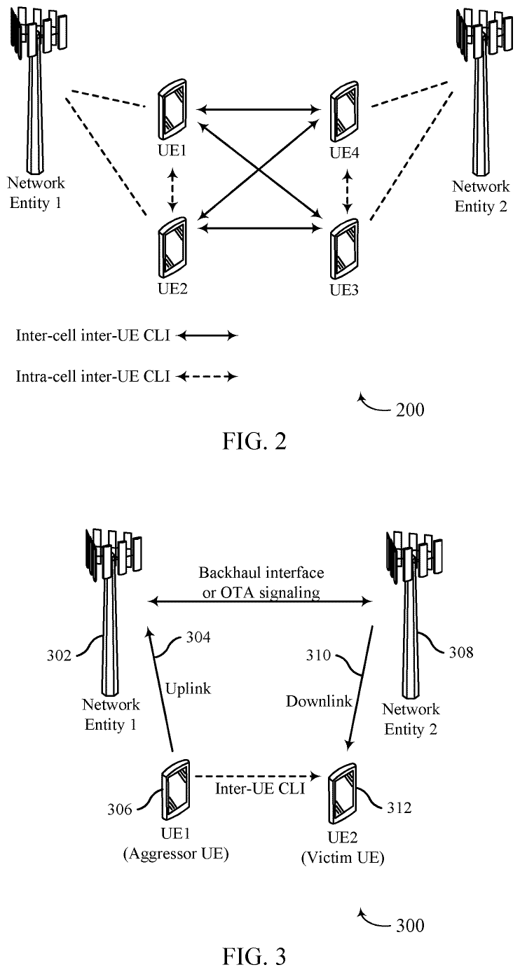

FIG. 3 illustrates an example 300 of inter-cell inter-UE CLI that supports interference measurement timing adjustment in accordance with aspects of the present disclosure. The example 300 is an example scenario of inter-UE CLI when employing dynamic TDD, full-duplex, SBFD, or other enhanced duplexing methods. In the example 300, a first network entity 302 is receiving an uplink (UL) signal 304 from a first user equipment 306, while a second network entity 308 is transmitting a downlink (DL) signal 310 to a second user equipment 312. While receiving the DL signal 310, the UL signal 304 from the UE 306 may interfere with the DL signal 310 to the UE 312, degrading the signal quality at the UE 312. The UE 306 is referred to as the aggressor UE and the UE 312 is referred to as the victim UE in the example 300.

In order to combat the adverse effect of CLI, the UE 312 may measure the CLI from the UE 306 prior to the communications. The result of CLI measurements may then be used by one or both of the UE 312 directly or the network entity 308 for link adaptation, scheduling, beamforming, or other CLI handling actions. Further details on CLI configuration, measurement, reporting, and handling are discussed below.

For ease of reference, the above example scenario is used for describing various implementations and examples herein. UE1 and UE2 refer to aggressor and victim UEs, respectively. Network entity 1 (NE1) and network entity 2 (NE2) provide serving cells for UE1 and UE2, respectively. The NE1 may be a base station (e.g., BS1) and the network entity 2 may be a base station (e.g., BS2). Examples of UE2 may be able to detect SSBs from NE1 without establishing a connection with NE1. Similarly, UE1 may be able to detect SSBs from NE2 without establishing a connection with NE2.

According to one implementation, UE2 receives, from NE2, an indication of a timing offset to apply when performing CLI measurement on the resource(s) configured or indicated for CLI measurement. In one example, the timing offset is to be applied with respect to a reference point in time, e.g., a reception time of an SSB from NE2. In another example, the reference point may be a reception time of an SSB from NE1.

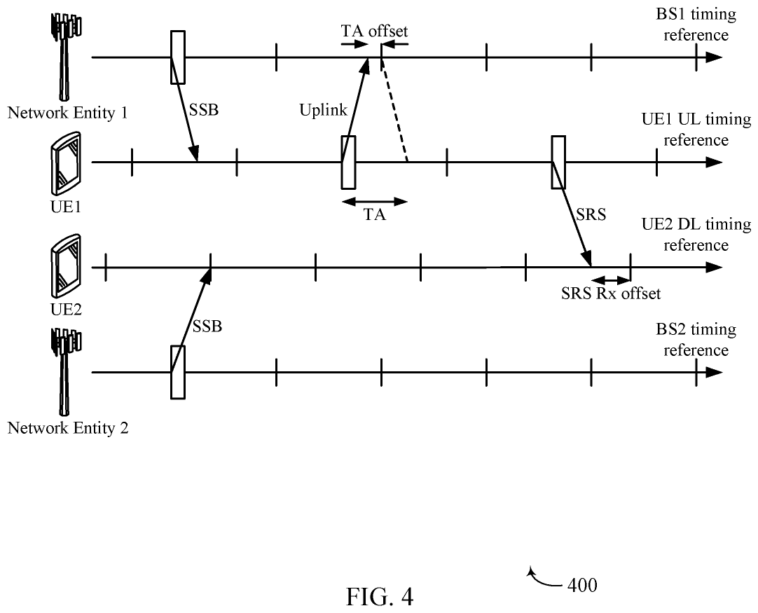

FIG. 4 illustrates an example 400 of a timeline for applying an SRS Rx offset that supports interference measurement timing adjustment in accordance with aspects of the present disclosure. The timeline of example 400 illustrates how UE2 may apply a timing offset when receiving SRS from UE1. The timing offset is called SRS Rx offset in this example.

Several parameters affect the timing offset in this scenario:
Tₚ₁=propagation delay between NE1 and UE1
Tₚ₂=propagation delay between NE2 and UE2
T_{TA,offset1}=TA offset configured for UE1
Tₚᵤ=propagation delay between UE1 and UE2

Assuming that SSB transmissions are synchronized between NE1 and NE2, the timing offset T_{CLI,Rx,offset} can be obtained by:

$${T}_{CLI , Rx , offset} = {T}_{TA} + {T}_{p 2} - {T}_{pu} = 2 \cdot {T}_{p 1} + {T}_{TA , offset 1} + {T}_{p 2} - {T}_{pu}$$

This equation provides a value of timing offset that UE2 may apply in advance of the timing reference obtained by receiving SSB from NE2. Therefore, the value may also be referred to as SRS Rx timing advance offset or similar terms. When the CLI is measured based on SRS, the timing offset T_{CLI,Rx,offset} can also be referred to as the SRS Rx offset (e.g., timing offset T_{SRS,Rx,offset}) or similar terms.

This method may be more desirable if applying a Tx timing offset at UE1 is not feasible due to intra-cell inter-UE CLI issues. But the method may be less desirable if applying an Rx timing offset may conflict with timing adjustment for other (potentially simultaneous) receptions by UE2. In some examples, NE2 may not schedule another reception for UE2 on one or both of the symbol on which UE2 receives or measures the CLI, or one or multiple consecutive symbol(s) before or after the symbol. In some examples, to one or both of avoid timing adjustment conflicts or to avoid CLI, NE2 may puncture REs, on the consecutive symbol(s), that are on the same subcarriers as the SRS or CLI REs on the symbol.

The values of the several parameters and propagation delays may be obtained by exchanging information of network entity and UE locations, TA offset, and so on. However, in various implementations, not all the information may be available or accurate.

In one example, NE2 may receive an indication of the timing offset from NE1 via a backhaul or via an OTA signaling. In this example, NE1 may obtain an estimate of the timing offset based on at least one of: its own location, which may be obtained by GPS/GNSS or via OAM; the location of NE2, which may be obtained by GPS/GNSS, and then shared with NE1 by signaling, or via OAM; an approximate location of UE1, which may be obtained by a TA-based location estimation at NE1 or other positioning methods; or an approximate location of UE2, which may be obtained based on the knowledge that UE2 is located at a cell edge of NE2, based on the knowledge that NE2 is a small cell BS with a relatively small coverage area, or the like.

In another example, NE2 may obtain an estimate of the timing offset based on at least one of: its own location, which may be obtained by GPS/GNSS or via OAM; the location of NE1, which may be obtained by GPS/GNSS, and then shared with NE2 by signaling, or via OAM; an approximate location of UE2, which may be obtained by a TA-based location estimation at NE2 or other positioning methods; or an approximate location of UE1, which may be obtained based on the knowledge that UE1 is located at a cell edge of NE1, based on the knowledge that NE1 is a small cell BS with a relatively small coverage area, or the like.

In yet another example, NE2 may obtain an estimate of the timing offset based on a combination of the above, such its own location, the location of NE1, an approximate location of UE2, and an approximate location of UE1, which may be obtained by NE1 by a TA-based location estimation or other positioning methods, and then indicated to NE2 via a backhaul or via an OTA signaling.

In various examples, NE1 may use the value of TA offset or otherwise indicate the value to NE2. In the latter case, NE2 may use the indicated value to obtain the timing offset.

Additionally or alternatively, NE1 may configure one or more SRS for multiple UE1s (e.g., aggressor UEs) in a location region (which may also be referred to as a geographical location or a geographical region) and indicate information of the SRS configuration and the associated geographical location to NE2. NE2 may then use the information to indicate an SRS Rx offset to one or more UE2s (e.g., victim UE2s). Then, each of the UE2s may apply the indicated timing offset when receiving the SRS and measuring the CLI.

In various examples, if one of the UE2s leaves the geographical area, NE2 may indicate a new value of SRS Rx offset, unconfigure the associated CLI reporting, or take a similar action.

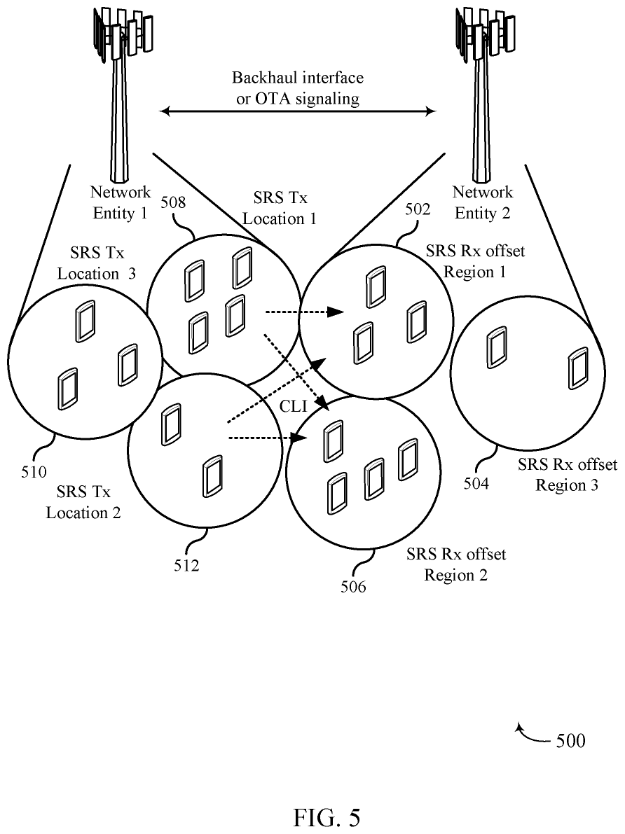

FIG. 5 illustrates an example 500 of timing offset regions that supports interference measurement timing adjustment in accordance with aspects of the present disclosure. The example 500 is an example scenario for at least one of timing offset regions for CLI measurement, or center locations or regions for SRS transmission. In the example 500, UE2s close to the cell edge are configured with CLI reporting and indicated multiple values of SRS Rx offset associated with multiple regions. The UE2s are illustrated in locations or regions 502, 504, and 506. The UE1s are illustrated in locations or regions 508, 510, and 512.

In one example, a region may be indicated by center coordinates and a radius. In another example, a region may be indicated by center coordinates. In yet another example, a region may be indicated by vertices of a polygon.

Additionally or alternatively, NE2 may indicate a center location or region (e.g., at least one of regions 508, 510, or 512) associated with the transmission points(s) of the SRS. Then, as UE2 moves from one location to another, UE2 may acquire an estimate of its own location and use it to compute an SRS Rx offset to apply when receiving the SRS for measuring CLI.

In various examples, UE2 may acquire an estimate of its own location, through GPS/GNSS or other positioning methods, in order to determine an SRS Rx offset to apply.

Additionally or alternatively, NE2 indicates to UE2 M timing offset values instead of indicating one timing offset value dynamically. Then UE2 obtains M CLI measurement results associated with the M timing offset values, where each CLI measurement is obtained by applying one of the M timing offset values. Next, UE2 transmits a CLI report to NE2, where the CLI report includes one or multiple CLI measurement results.

In one example, the CLI report includes a CLI value equal to a maximum (e.g., worst-case) of the M CLI measurement results. This is a conservative option, which may increase packet success rate at the cost of resource underutilization.

In another example, the CLI report includes a CLI value equal to the minimum (e.g., best-case) of the M CLI measurement results. This is an aggressive option, which may improve resource utilization at the risk of increased packet error rate.

In another example, the CLI report includes a CLI value equal to the average or weighted average of the M CLI measurement results. This option aims at striking a balance between reporting maximum and minimum CLI.

In yet another example, the CLI report includes all the M CLI values. In some implementations, NE2 may obtain a maximum, minimum, average, or weighted average of the M reported CLI values according to a configuration, a standard specification, or an implementation. Additionally or alternatively, NE2 may obtain an estimate of the timing offset and use the estimate to select one of the reported M CLI values. A potential advantage of this implementation is that it does not require NE2 to indicate a timing offset to UE2 dynamically. Another potential advantage is that it allows NE2 more time to obtain the timing offset estimate-instead of obtaining the estimate at the time of measurement, NE2 may obtain the estimate later when scheduling communication with UE2.

By extension, in yet another example, the CLI report may include N of the M CLI measurement results. The N CLI values may be the largest or the smallest of the M CLI values in some implementations. Additionally or alternatively, each of the N CLI values may be equal to an average or a weighted average of one or multiple of the M CLI measurement results.

The values of one or both of M or N in various examples may be configured by the network (e.g., by an RRC configuration), indicated to UE2 by a L1/L2 signaling from NE2, or specified by a standard. The values of one or both of M or N in various examples may depend on a capability of UE2, which may be indicated to NE2 prior to the RRC configuration or L1/L2 signaling.

In various examples, the UE behavior with respect to the number of CLI values in the CLI report and how each CLI value is obtained may be configured by the network (e.g., by an RRC configuration), indicated to UE2 by a L1/L2 signaling from NE2, or specified by the standard.

Additionally or alternatively, UE1 receive, from NE1, a timing offset to apply when transmitting the SRS.

In one example, the timing offset is to be applied with respect to a reference point in time, e.g., a UL transmission time according to an indicated timing advance (TA).

In one example, the timing offset is to be applied with respect to a reference point in time, e.g., a reception time of an SSB from NE2. In another example, the reference point may be a reception time of an SSB from NE1.

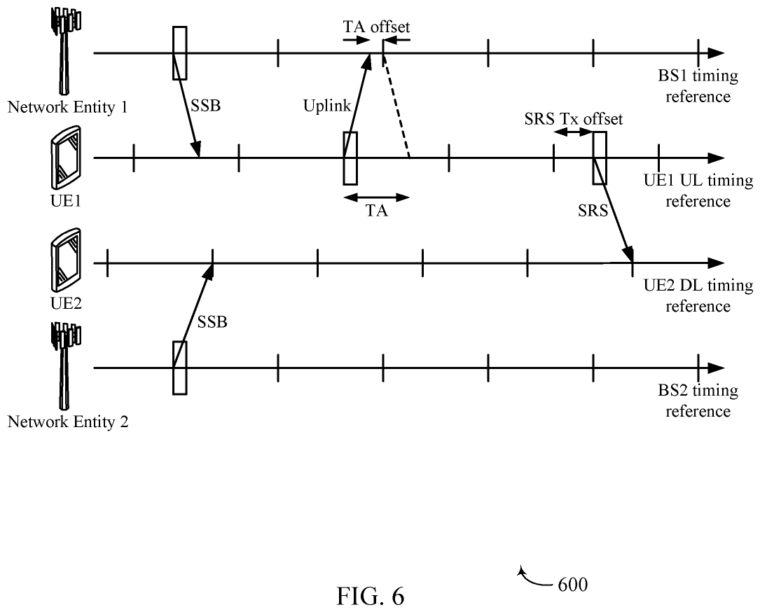

FIG. 6 illustrates an example 600 of a timeline for applying an SRS Tx offset that supports interference measurement timing adjustment in accordance with aspects of the present disclosure. The timeline of example 600 illustrates how UE1 may apply a timing offset when transmitting SRS. The timing offset is called SRS Tx offset in this example.

Several parameters affect the timing offset in this scenario: Tₚ₁, Tₚ₂, T_{TA,offset1}, Tₚᵤ as discussed above. If it is intended to obtain a timing offset that is applied in advance of the timing obtained by TA, the new timing offset T_{CLI,Tx,offset} can be set to:

$${T}_{CLI , Tx , offset} = - {T}_{CLI , Rx , offset} = - {T}_{TA} - {T}_{p 2} + {T}_{pu} = - 2 \cdot {T}_{p 1} - {T}_{TA , offset 1} - {T}_{p 2} + {T}_{pu}$$

UE1 may apply this timing offset in advance of the timing reference obtained by receiving SSB from NE1 and applying TA. Therefore, the value may also be referred to as SRS Tx timing advance offset (e.g., timing offset T_{SRS,Tx,offset}) or similar terms.

This method may be less desirable if one or both of applying a Tx timing offset may cause an intra-cell CLI from UE1 on other UEs served by NE1, or if applying a Tx timing offset may conflict with timing adjustment for other (potentially simultaneous) transmissions by UE1. In some examples, NE1 may not schedule another transmission for UE1 on one or both of the symbol on which UE1 transmits the SRS, or one or multiple consecutive symbol(s) before or after the symbol. In some examples, to one or both of avoid timing adjustment conflicts or to avoid CLI, NE1 may puncture REs, on the consecutive symbol(s), that are on the same subcarriers as the SRS REs on the symbol.

The values of the several parameters and propagation delays may be obtained by exchanging information of network entity and UE locations, TA offset, and so on. However, in various implementations, not all the information may be available or accurate.

In one example, NE1 may receive an indication of the timing offset from NE2 via a backhaul or via an OTA signaling. In this example, NE2 may obtain an estimate of the timing offset based on at least one of: its own location, which may be obtained by GPS/GNSS or via OAM; the location of NE1, which may be obtained by GPS/GNSS, and then shared with NE2 by signaling, or via OAM; an approximate location of UE2, which may be obtained by a TA-based location estimation at NE2 or other positioning methods; or an approximate location of UE1, which may be obtained based on the knowledge that UE1 is located at a cell edge of NE1, based on the knowledge that NE1 is a small cell BS with a relatively small coverage area, or the like.

In another example, NE1 may obtain an estimate of the timing offset based on at least one of: its own location, which may be obtained by GPS/GNSS or via OAM; the location of NE2, which may be obtained by GPS/GNSS, and then shared with NE1 by signaling, or via OAM; an approximate location of UE1, which may be obtained by a TA-based location estimation at NE1 or other positioning methods; or an approximate location of UE2, which may be obtained based on the knowledge that UE2 is located at a cell edge of NE2, based on the knowledge that NE2 is a small cell BS with a relatively small coverage area, or the like.

In yet another example, NE1 may obtain an estimate of the timing offset based on a combination of the above, such as: its own location; the location of NE2; an approximate location of UE1; or an approximate location of UE2, which may be obtained by NE2 by a TA-based location estimation or other positioning methods, and then indicated to NE1 via a backhaul or via an OTA signaling.

In various examples, NE1 may use the value of TA offset to obtain the timing offset.

Additionally or alternatively, NE1 configure one or more SRS for multiple UE1s (e.g., aggressor UEs) in a geographical region and indicate an associated SRS Tx offset. Then, each of the UE1s applies the indicated timing offset when transmitting the SRS. The multiple UE1s may transmit SRS on one or both of different symbols or different REs on a symbol, as configured by NE1. Additionally or alternatively, a subset of the UE1s may transmit the SRS at a time based on an explicit indication, such as an activation, deactivation or triggering signaling, or based on implicit determination.

In various examples, if a UE1 leaves the geographical area, NE1 may indicate a new value of SRS Tx offset, unconfigure the SRS transmission, or take a similar action.

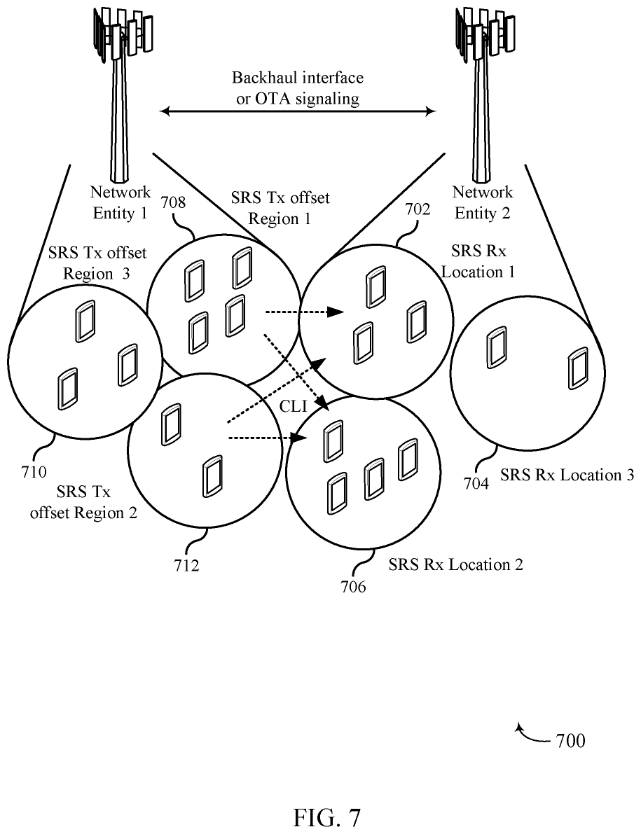

FIG. 7 illustrates an example 700 of timing offset regions that supports interference measurement timing adjustment in accordance with aspects of the present disclosure. The example 700 is an example scenario for at least one of timing offset regions for SRS transmission, or center locations or regions for CLI measurement. In the example 700 UE1s close to the cell edge are configured with multiple SRS transmissions and indicated multiple values of SRS Tx offset associated with the multiple regions. The UE2s are illustrated in locations or regions 702, 704, and 706. The UE1s are illustrated in locations or regions 708, 710, and 712.

In one example, a region may be indicated by center coordinates and a radius. In another example, a region may be indicated by center coordinates. In yet another example, a region may be indicated by vertices of a polygon.

Additionally or alternatively, NE1 may indicate a center location or region (e.g., at least one of regions 708, 710, or 712) associated with CLI measurement point(s). Then, as UE1 moves from one location to another, UE2 may acquire an estimate of its own location and use it to compute an SRS Tx offset to apply when transmitting the SRS.

In various examples, UE1 may acquire an estimate of its own location, through GPS/GNSS or other positioning methods, in order to determine an SRS Tx offset to apply.

Additionally or alternatively, one or both of UEL or UE2 establishes a dual connection (DC) with NE1 and NE2. The dual connectivity can then be used for faster exchange of information.

In one example, UE1 establishes a DC with NE2. Then, NE2 indicates to UE1 one or both of an SRS Tx offset or other information UE1 may use to obtain a timing offset for transmitting SRS. UE1 then uses the indicated information for transmitting SRS.

In another example, UE2 establishes a DC with NE1. Then, NE1 indicates to UE2 one or both of an SRS Rx offset or other information UE2 may use to obtain a timing offset for receiving SRS. UE2 then uses the indicated information for receiving SRS and performing a CLI measurement.

Additionally or alternatively, UE1 transmits a reference signal from which UE2 acquires a reception timing. This reference signal may be a synchronization signal (SS) type of reference signal.

In one example, the SS type reference signal is used by UE2 for timing acquisition. UE2 then uses the acquired timing for receiving at least one of SRS from UE1 or other UEs in the vicinity of UE1, and performing CLI measurements. One advantage of this method is that it allows UE1 to transmit the SS type reference signal infrequently. Another advantage is that one UE1 may transmit the SS type reference signal on behalf of multiple UEs in its vicinity.

In another example, the SS type reference signal is used by UE2 for CLI measurement as well.

In various examples, information of the SS type reference signal is communicated among network entities (e.g., base stations).

In one example, NE1 configures UE1 with an SS type reference signal and communicates information of the SS type reference signal to NE2. The information may include information of resources associated with the SS type reference signals, one or multiple reference signal sequence seeds or IDs, and the like. Then, NE2 configures UE2 with one or both of a timing acquisition or CLI measurement and reporting based on the information of the SS type reference signal. Then, UE1 transmits the SS type reference signal(s), at least in part, according to the configuration from NE1; while UE2 receives and performs one or both of timing acquisition or CLI measurement and reporting on the SS type reference signals, at least in part, according to the configuration from NE2.

In another example, some of the elements may be one or both of swapped between NE1 and NE2 or swapped between UE1 and UE2.

Additionally or alternatively, a phase rotation similar to RIM-RS may be applied to reference signal transmission by UE1.

In various examples, information of the phase-rotated reference signal is communicated among network entities (e.g., base stations).

In one example, NE1 configures UE1 with a phase-rotated reference signal and communicates information of the phase-rotated reference signal to NE2. The information may include information of resources associated with the SS type reference signals, one or multiple phase rotation parameters, and the like. Then, NE2 configures UE2 with one or both of a timing acquisition or CLI measurement and reporting based on the information of the phase-rotated reference signal. Then, UE1 transmits the phase-rotated reference signal(s), at least in part, according to the configuration from NE1; while UE2 receives and performs one or both of timing acquisition or CLI measurement and reporting on the phase-rotated reference signals, at least in part, according to the configuration from NE2.

In another example, some of the elements may be one or both of swapped between NE1 and NE2 or swapped between UE1 and UE2.

With respect to a Tx timing offset, various implementations and examples discussed herein include an element of applying a timing offset when transmitting a signal.

In several implementations, applying a timing offset such as T_{CLI,Tx,offset} for transmitting SRS includes applying a Tx timing equal to:

$${T}_{CLI , Tx , offset} = {N}_{CLI , Tx , offset} \cdot {T}_{c} = ( {N}_{1} + {N}_{2} ) \cdot {T}_{c}$$

where N_{CLI,Tx,offset} is an integer and T_{c}=0.509 nanoseconds (ns) in 5G NR. A value of N_{CLI,Tx,offset} may be determined based on one or more of a configuration, an L1/L2 signaling, or a geographical location.

In some examples, N_{CLI,Tx,offset}=N₁+N₂, where: N₁ is variable and determined based on one or more of a configuration, an L1/L2 signaling, or a geographical location; N₂ is constant and determined based on one or more of a standard specification, a configuration, or an L1/L2 signaling.

In one example, the timing offset T_{CLI,Tx,offset} is applied in addition to a legacy TA, e.g., a new timing advance equal to T_{TA}+T_{CLI,Tx,offset} is applied while transmitting the subject signal (e.g., the associated SRS). In this example, T_{TA} denotes the legacy TA, which may be obtained according to 3rd Generation Partnership Project (3GPP) technical specification (TS) 38.211, Section 4.3.1.

In another example, the timing offset T_{CLI,Tx,offset} is applied instead of a legacy TA.

In some examples, T_{CLI,Tx,offset} or T_{TA}+T_{CLI,Tx,offset} may be positive or negative. Applying a negative timing advance means transmitting the signal after the time mark instead of transmitting it in advance of the time mark. The time mark is, for example, the reception time of SSB from the serving cell.

With respect to a Rx timing offset, various implementations and examples discussed herein include an element of applying a timing offset when one or both of receiving a signal or performing a measurement.

In several implementations, applying a timing offset such as T_{CLI,Rx,offset} for one or both of receiving SRS or measuring CLI includes applying an Rx timing equal to:

$${T}_{CLI , Rx , offset} = {N}_{CLI , Rx , offset} \cdot {T}_{c} = ( {N}_{1} + {N}_{2} ) \cdot {T}_{c}$$

where N_{CLI,Rx,offset} is an integer and T_{c}=0.509 ns in 5G NR. A value of N_{CLI,Rx,offset} may be determined based on one or more of a configuration, an L1/L2 signaling, or a geographical location.

In some examples, N_{CLI,Rx,offset}=N₁+N₂, where: N₁ is variable and determined based on one or more of a configuration, an L1/L2 signaling, or a geographical location; N₂ is constant and determined based on one or more of a standard specification, a configuration, or an L1/L2 signaling.

In one example, the timing offset T_{CLI,Rx,offset} is applied with respect to a reference point in time, e.g., a reception time of an SSB from a serving cell. In another example, the reference point may be a reception time of an SSB from a non-serving cell such as the cell serving an aggressor UE.

With respect to timing offset based on geographical locations, in various implementations and examples discussed herein, a timing offset may be determined based on one or more geographical locations.

In several examples, a timing offset based on propagation delay between geographical points P₁ and P₂ may be obtained as:

$${T}_{offset} = {N}_{offset} \cdot {T}_{c} = ( {N}_{1} + {N}_{2} ) \cdot {T}_{c}$$

In one example, N_{offset}=[Tₚᵣₒₚ/T_{c}], where Tₚᵣₒₚ=d/c denotes the propagation delay of signals traveling at the speed of light c over a distance d=|P₂−P₁|, and [·] denotes rounding or floor or ceiling function.

In another example, N_{offset}=N₁+N₂, where N₁=[Tₚᵣₒₚ/T_{c}] is a function of the distance d and N₂ is a constant.

The timing offset may be applied for transmission or reception. If for transmission, the timing offset may or may not be added to a legacy TA. If for reception, the timing offset may be applied with respect to a reference point in time as described above.

In one example, the timing offset may be applied when a device (e.g., an aggressor UE) is near point P₁, has obtained a location estimate equal to P₁, associated with a region including P₁, associated with a region centered at P₁, or the like.

In another example, the timing offset may be applied when a device (e.g., a victim UE) is in point P₂, near point P₂, has obtained a location estimate equal to P₂, associated with a region including P₂, associated with a region centered at P₂, or the like.

In yet another example, a combination of the above may be applied, e.g., an aggressor UE is in point P₁ and a victim UE is in point P₂, or the like.

Configurations and L1/L2 signaling are discussed in the following. In various implementations and examples, configurations for CLI acquisition may include one or more of: a configuration of reference signals such as SRS for the (potential) aggressor UE; a configuration of one or both of CLI measurements or reporting for the (potential) victim UE; a configuration of related Tx or Rx such as transmitting positioning reference signals or performing UE positioning measurements; or a configuration of related behaviors such as one or more of acquisition or application of timing offsets according to an L1/L2 signaling, a location estimate, or the like.

The configuration may be performed by RRC/L3 signaling or higher layer signaling. In some examples, multiple of the above may be included by one configuration message or information element (IE). Conversely, a configuration may be delivered in multiple configuration messages or IEs or delivered incrementally over time.

For CLI measurements based on SRS Tx/Rx, NE1 may configure UE1 (or multiple UE1s) with one or more SRS, which may be associated, in part, with one or more UE1 beam configurations (Tx spatial filters). For CLI measurements based on SRS Tx/Rx, NE2 may configure UE2 (or multiple UE2s) with one or more instances of SRS-RSRP reporting, which may be associated, in part, with multiple UE2 beam configurations (Rx spatial filters).

Then, UE1 transmits SRS according to the SRS configuration(s) on the resources indicated, at least in part, by the SRS configuration(s); and UE2 receives and measures signals on the resources according to the SRS-RSRP reporting configuration(s) and obtains one or more values of SRS-RSRP, which can then be reported to NE2 according to the SRS-RSRP reporting configuration(s).

For CLI measurements based on RSSI measurements, NE1 may or may not configure UE1 (or multiple UE1s) with signal transmissions associated, in part, with one or more UE1 beam configurations (Tx spatial filters). For CLI measurements based on RSSI measurements, NE2 may configure UE2 (or multiple UE2s) with one or more instances of CLI-RSSI reporting, which may be associated, in part, with multiple UE2 beam configurations (Rx spatial filters).

Then, UE2 receives and measures signals on resources according to the CLI-RSSI reporting configuration(s) and obtains one or more values of CLI-RSSI, which can then be reported to NE2 according to the CLI-RSSI reporting configuration(s). If configured, UE1 may transmit signals according to the signal transmission configuration(s) on the resources indicated, at least in part, by the signal transmission configuration(s). It should be noted that unlike SRS-RSRP measurement and reporting, CLI-RSSI measurement and reporting may not depend on any configured or coordinated transmissions by the aggressor UE(s). This simplifies signaling at the cost of measurement accuracy.

The CLI framework specified in Release 16 specifies SRS-RSRP and CLI-RSSI reporting at L3, e.g., the measurements are filtered at layer 3 and reported by RRC signaling. Using the techniques discussed herein, the measurements (one or both of SRS-RSRP or CLI-RSSI measurements), filtering, and reporting may be performed at L1, L2, L3, or a combination thereof.

It should be noted that other types of CLI acquisition may also be used. Various implementations and examples proposed in the discussion herein are similarly applicable to other types of signal transmissions, reference signal transmissions, L1/L2/L3 measurements, L1/L2/L3 filtering, L1/L2/L3 reporting, and so on.

Furthermore, various implementations and examples discussed herein may be preceded, or include, capability signaling that indicate the capability of an entity. The following are examples. For a UE: capability to support a CLI acquisition method according to the techniques discussed herein; capability to apply a Tx and/or Rx timing offset in accordance with at least one of a configuration, signaling, or a location estimate; capability to perform L1/L2/L3 signaling in accordance with the techniques discussed herein; capability to perform positioning; number of Tx antennas, panels, or beams; and so forth. For a network entity (e.g., base station): capability to support a CLI acquisition method according to the techniques discussed herein; capability to perform a related backhaul or OTA signaling; capability to support positioning; and so forth.

With respect to backhaul or over-the-air (OTA) signaling, various implementations and examples discussed herein include one or more information exchanges between base stations. The information exchange may be performed over one or more of: directly over a backhaul interface such as Xn; indirectly through a core network function, e.g., one or both of an AMF or LMF, over backhaul interfaces such as NG; or via OTA signaling.

In various implementations and examples, information of reference signal configurations, CLI acquisition configurations, locations, location regions, one or both of propagation delays or timing offsets, capabilities of entities to support a CLI acquisition method, and the like may be exchanged over backhaul interfaces such as Xn, NG, and so on.

Additionally, or alternatively, some of the aforementioned signaling may OTA.

With respect to an expiration timer for timing offset, also referred to as a countdown expiration timer, in several examples a validity timer may be configured or signaled in association with a timing offset. The initial value for the validity timer may be determined based on one or more of a velocity of the transmitter, a velocity of the receiver, a relative velocity between the transmitter and the receiver, a location of the transmitter or receiver or both, or a similar parameter.

In some examples, one or both of UE1 or UE2 may be configured or signaled one or both of an expiration timer or a validity duration in association with a timing offset. Additionally or alternatively, one or both of UE1 or UE2 may obtain one or both of an expiration timer or validity duration based on a parameter such as its velocity. Then, one or both of the UE1 or UE2 may apply the associated Tx timing offset or Rx timing offset as long as the timer has not expired, or the timing offset is still valid.

In some examples, expiration of the validity timer may indicate that a new timing offset should be determined. In some examples, a UE may determine whether to continue applying the timing offset based on determining whether the associated validity timer is expired.

In various examples, once a new value of the timing offset is signaled or determined, the associated validity timer may be reset to its initial value.

With respect to positioning-assisted methods and SRS sharing, various implementations and examples discussed herein may make use of information of a UE's position estimate or an approximate position estimate in order to obtain information related to propagation delays among UEs, timing offsets, and the like. In several descriptions, a network entity (e.g., a base station) may obtain an estimate of a UE's approximate position through using direction of a beam towards the UE, TA of the UE, and the like. Such methods may provide an estimate of the UE's position with an accuracy of tens of meters.

More accurate positioning is possible by which more accurate values for propagation delays and timing offsets can be obtained. LTE and NR support positioning of UEs by various methods specified in the standard.

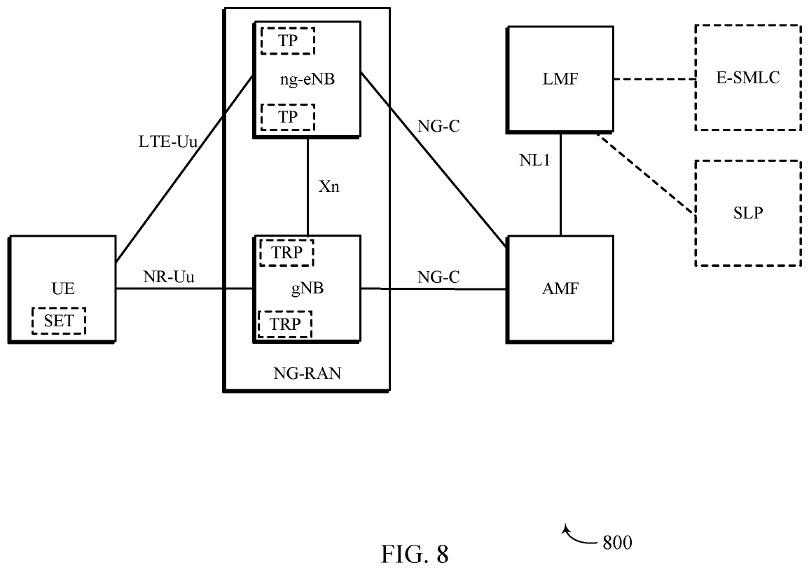

FIG. 8 illustrates an example 800 of a UE positioning architecture that supports interference measurement timing adjustment in accordance with aspects of the present disclosure. The example 800 illustrates a UE Positioning Overall Architecture Applicable to NG-RAN. The example 800 shows the architecture in 5GS applicable to positioning of a UE with NR or evolved universal terrestrial radio access (E-UTRA) access as discussed in 3GPP TS 38.305. According to the stage 2 specifications of 3GPP TS 38.305, the AMF receives a request for a location service associated with a particular target UE, or the AMF itself decides to initiate a location service on behalf of a particular target UE. The AMF then sends a location services request to an LMF. The LMF processes the location services request which may include one or more of transferring assistance data to the target UE to assist with one or both of UE-based or UE-assisted positioning, positioning of the target UE. The LMF then returns the result of the location service back to the AMF. In the case of a location service requested by an entity other than the AMF, the AMF returns the location service result to that entity.

The LMF manages the support of different location services for target UEs, including positioning of UEs and delivery of assistance data to UEs. The LMF may interact with the serving network entity (e.g., serving gNB or serving ng-eNB) for a target UE in order to obtain position measurements for the UE, including uplink measurements made by an NG-RAN and downlink measurements made by the UE that were provided to an NG-RAN as part of other functions such as for support of handover.

The LMF may interact with a target UE in order to deliver assistance data if requested for a particular location service, or to obtain a location estimate if that was requested. The LMF may interact with multiple NG-RAN nodes (e.g., base stations) to provide assistance data information for broadcasting. The assistance data information for broadcast may optionally be one or both of segmented or ciphered by the LMF. The LMF may also interact with AMFs to provide ciphering key data information to the AMF.

Various implementations of the present disclosure may use UE positioning information. Examples are as follows. In the descriptions, UE1 is a potentially aggressor UE connected to a NE1 (e.g., a base station), and UE2 is a potentially victim UE connected to a NE2 (e.g., another base station). Any of the examples may be combined with an implementation or example described above.

In one example, NE1 may obtain an estimate of the location of UEL through signaling with an LMF. The signaling with the LMF may occur over the backhaul with a core network function such as an AMF. NE1 may send a request for the location information associated with UE1 and receive the location information in response. In this process, if the LMF does not have the location information, it may initiate a positioning process, which may involve NE1 itself.

In another example, NE1 may obtain the location information by computing an estimate locally at NE1.

In some examples, once NE1 obtains the location information, it may exchange the information with NE2 or another entity.

Similarly, in one example, NE2 may obtain an estimate of the location of UE2 through signaling with an LMF. The signaling with the LMF may occur over the backhaul with a core network function such as an AMF.

In another example, NE2 may obtain the location information by computing an estimate locally at NE2.

In some examples, once NE2 obtains the location information, it may exchange the information with NE1 or another entity.

Additionally or alternatively, a network entity (e.g., a gNB, an NG-RAN node) may obtain an estimate of the location of a UE it is not serving. In one example, NE1 may obtain an estimate of the location of UE2 through signaling with the LMF. In another example, NE2 may obtain an estimate of the location of UE1 through signaling with the LMF. In either case, signaling between one base station (e.g., NE1 or NE2, respectively) and the LMF for obtaining information of the location of a target UE in another cell (e.g., UE2 or UE1, respectively) may involve one or both of signaling with or configurations by the other base station serving the target UE (e.g., NE2 or NE1, respectively).

In some examples, positioning may be performed by means of measuring SRS transmitted by UE1, which may be identical to, or overlap with, the SRS that UE1 transmits for CLI measurements.

In some examples, the SRS configured for one or both of positioning or CLI measurements may be used by NE1, NE2, or UE2 to obtain an estimate of UE1's location. The estimate may then be used directly or indirectly (for example, jointly with other configuration information) to employ a method proposed herein.

In a typical scenario, wireless channels are reciprocal, and hence, a first CLI from UE1 at UE2 may be expected to be similar or identical to a second CLI from UE2 at UE1. In other words, if DL/UL directions of communication are reversed, UE2 may become a potential aggressor UE and UE1 may become a potential victim UE. In some examples, one or both of UE1 or UE2 may be configured with SRS or other means of positioning, through which an estimate of the location may be obtained. The estimates may then be used in combination with a method described herein to obtain an estimate of one or both of the first CLI or the second CLI.

In several examples, an SRS configuration may indicate to a UE that the SRS is for one or both of positioning or CLI measurements. The UE may then perform tasks associated with one or both of positioning or CLI measurements, potentially according to a unified scheme, as specified by the standard or indicated by a configuration.

The following should be noted with respect to the techniques discussed herein.

The different steps or acts described for the example implementations, in the text and in the flowcharts, may be permuted.

Each configuration may be provided by one or more configurations in practice. An earlier configuration may provide a subset of parameters while a later configuration may provide another subset of parameters. Additionally or alternatively, a later configuration may override values provided by an earlier configuration or a pre-configuration.

A configuration may be provided by one or more of an Xn/NG signaling, a radio resource control (RRC) signaling, a medium-access control (MAC) signaling, a physical layer signaling such as a downlink control information (DCI) message, or other methods. A configuration may include a pre-configuration or a semi-static configuration provided by at least one of the standard, the vendor, the network or operator (e.g., OAM). Each parameter value received through configuration or indication may override previous values for a similar parameter.

L1/L2 control signaling may refer to control signaling in layer 1 (physical layer) or layer 2 (data link layer). Particularly, an L1/L2 control signaling may refer to an L1 control signaling such as one or more of a DCI message or a UCI message, or an L2 control signaling such as a MAC message. A format and an interpretation of an L1/L2 control signaling may be determined by at least one of the standard, a configuration, or other control signaling.

Reference is made herein to a message or an IE. ‘IE’ is an acronym used frequently in LTE and NR specifications for referring to a configuration at layer 3 and higher. An IE may be included in a message from one layer to another layer or from one entity to another entity. Additionally or alternatively, an IE may be included in another IE. In the discussion herein, the terms ‘IE’ and ‘message’ may be used interchangeably when the message includes the IE directly or indirectly.

Any parameter discussed herein may appear, in practice, as a linear function of that parameter in signaling or specifications.

There is discussion herein to perform measurements for beam training on reference signals. Additionally or alternatively, in some implementations, a measurement may be performed on resources that are not necessarily configured for reference signals, but rather a node may measure a receive signal power and obtain a receive signal strength indicator (RSSI) or the like.

In the discussions herein, reference is frequently made to beam indication. In practice, according to a standard specification, a beam indication may refer to an indication of a reference signal by an ID or indicator, a resource associated with a reference signal, a spatial relation information including information of a reference signal or a reciprocal of a reference signal (in the case of beam correspondence).

Despite emphasis on the use of SRS for inter-UE CLI measurements, other reference signals such as a new type of cross-link interference reference signals (CLI-RS) may be used for the purpose. Furthermore, various implementations and examples may be applied, as described or with modifications, to one or both of entities other than UEs or other types of interference.

The terms synchronization signal (SS), primary SS (PSS), secondary SS (SSS), SS block (SSB), SS/physical broadcast channel (PBCH) block, and the like may be used interchangeably or refer to signals with related functionalities.

In some implementations, the terms antenna, panel, and antenna panel are used interchangeably. An antenna panel may be a hardware that is used for transmitting and/or receiving radio signals at frequencies lower than 6 GHZ, e.g., frequency range 1 (FR1), or higher than 6 GHz, e.g., frequency range 2 (FR2) or millimeter wave (mmWave). In some implementations, an antenna panel may include an array of antenna elements, where each antenna element is connected to hardware such as a phase shifter that allows a control module to apply spatial parameters for transmission and/or reception of signals. The resulting radiation pattern may be called a beam, which may or may not be unimodal and may allow the device (e.g., UE, node, network entity) to amplify signals that are transmitted or received from one or multiple spatial directions.

In some implementations, an antenna panel may or may not be virtualized as an antenna port in the specifications. An antenna panel may be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In some implementations, capability information may be communicated via signaling or, in some implementations, capability information may be provided to devices without a need for signaling. In the case that such information is available to other devices such as a CU, it can be used for signaling or local decision making.

In some implementations, an antenna panel may be a physical or logical antenna array including a set of antenna elements or antenna ports that share a common or a significant portion of an RF chain (e.g., in-phase/quadrature (I/Q) modulator, analog to digital (A/D) converter, local oscillator, phase shift network). The antenna panel may be a logical entity with physical antennas mapped to the logical entity. The mapping of physical antennas to the logical entity may be up to implementation. Communicating (receiving or transmitting) on at least a subset of antenna elements or antenna ports active for radiating energy (also referred to herein as active elements) of an antenna panel requires biasing or powering on of the RF chain which results in current drain or power consumption in the device (e.g., node) associated with the antenna panel (including power amplifier/low noise amplifier (LNA) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In some implementations, depending on implementation, a “panel” can have at least one of the following functionalities as an operational role of Unit of antenna group to control its Tx beam independently, Unit of antenna group to control its transmission power independently, Unit of antenna group to control its transmission timing independently. The “panel” may be transparent to another node (e.g., next hop neighbor node). For certain condition(s), another node or network entity can assume the mapping between device's physical antennas to the logical entity “panel” may not be changed. For example, the condition may include until the next update or report from device or include a duration of time over which the network entity assumes there will be no change to the mapping. Device may report its capability with respect to the “panel” to the network entity. The device capability may include at least the number of “panels”. In one implementation, the device may support transmission from one beam within a panel; with multiple panels, more than one beam (one beam per panel) may be used for transmission. In another implementation, more than one beam per panel may be supported/used for transmission.

In some of the implementations described, an antenna port is defined such that the channel over which a symbol on the antenna port is conveyed can be inferred from the channel over which another symbol on the same antenna port is conveyed.

Two antenna ports are said to be quasi co-located (QCL) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. Two antenna ports may be quasi-located with respect to a subset of the large-scale properties and different subset of large-scale properties may be indicated by a QCL Type. The QCL Type can indicate which channel properties are the same between the two reference signals (e.g., on the two antenna ports). Thus, the reference signals can be linked to each other with respect to what the device can assume about their channel statistics or QCL properties. For example, qcl-Type may take one of the following values. Other qcl-Types may be defined based on combination of one or large-scale properties:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}.

Spatial Rx parameters may include one or more of: angle of arrival (AoA,) Dominant AoA, average AoA, angular spread, Power Angular Spectrum (PAS) of AoA, average AoD (angle of departure), PAS of AoD, transmit/receive channel correlation, transmit/receive beamforming, spatial channel correlation etc.

The QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the device may not be able to perform omni-directional transmission, e.g., the device would need to form beams for directional transmission. A QCL-TypeD between two reference signals A and B, the reference signal A is considered to be spatially co-located with reference signal B and the device may assume that the reference signals A and B can be received with the same spatial filter (e.g., with the same Rx beamforming weights).

An “antenna port” according to an implementation may be a logical port that may correspond to a beam (resulting from beamforming) or may correspond to a physical antenna on a device. In some implementations, a physical antenna may map directly to a single antenna port, in which an antenna port corresponds to an actual physical antenna. Alternately, a set or subset of physical antennas, or antenna set or antenna array or antenna sub-array, may be mapped to one or more antenna ports after applying complex weights, a cyclic delay, or both to the signal on each physical antenna. The physical antenna set may have antennas from a single module or panel or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some of the implementations described, a TCI-state (Transmission Configuration Indication) associated with a target transmission can indicate parameters for configuring a quasi-collocation relationship between the target transmission (e.g., target RS of demodulation (DM)-RS ports of the target transmission during a transmission occasion) and a source reference signal(s) (e.g., SSB/CSI-RS/SRS) with respect to quasi co-location type parameter(s) indicated in the corresponding TCI state. The TCI describes which reference signals are used as QCL source, and what QCL properties can be derived from each reference signal. A device can receive a configuration of a plurality of transmission configuration indicator states for a serving cell for transmissions on the serving cell (e.g., between a serving gNB and a smart repeater). In some of the implementations described, a TCI state includes at least one source RS to provide a reference (device assumption) for determining QCL and/or spatial filter.

In some of the implementations described, a UL TCI state is provided if a device is configured with separate DL/UL TCI by RRC signaling. The UL TCI state may include a source reference signal which provides a reference for determining UL spatial domain transmission filter for the UL transmission (e.g., dynamic-grant/configured-grant based physical uplink shared channel (PUSCH), dedicated physical uplink control channel (PUCCH) resources) in a component carrier (CC) or across a set of configured CCs/BWPs.

In some of the implementations described, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for device-dedicated physical downlink control channel (PDCCH)/physical downlink shared channel (PDSCH)) and is used to determine UL spatial transmission filter (e.g., for UE-dedicated PUSCH/PUCCH) for a CC or across a set of configured CCs/BWPs. In one example, the UL spatial transmission filter is derived from the RS of DL QCL Type D in the joint TCI state. The spatial setting of the UL transmission may be according to the spatial relation with a reference to the source RS configured with qcl-Type set to ‘typeD’ in the joint TCI state.

In some of the implementations described, a spatial relation information associated with a target transmission can indicate parameters for configuring a spatial setting between the target transmission and a reference RS (e.g., SSB/CSI-RS/SRS). For example, the device may transmit the target transmission with the same spatial domain filter used for reception the reference RS (e.g., DL RS such as SSB/CSI-RS). In another example, the device may transmit the target transmission with the same spatial domain transmission filter used for the transmission of the reference RS (e.g., UL RS such as SRS). A device can receive a configuration of a plurality of spatial relation information configurations for a serving cell for transmissions on the serving cell.

In some of the implementations described, a UL TCI state is provided if a device is configured with separate DL/UL TCI by RRC signaling. The UL TCI state may include a source reference signal which provides a reference for determining UL spatial domain transmission filter for the UL transmission (e.g., dynamic-grant/configured-grant based PUSCH, dedicated PUCCH resources) in a CC or across a set of configured CCs/BWPs.

In some of the implementations described, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides QCL Type-D indication (e.g., for device-dedicated PDCCH/PDSCH) and is used to determine UL spatial transmission filter (e.g., for UE-dedicated PUSCH/PUCCH) for a CC or across a set of configured CCs/BWPs. In one example, the UL spatial transmission filter is derived from the RS of DL QCL Type D in the joint TCI state. The spatial setting of the UL transmission may be according to the spatial relation with a reference to the source RS configured with qcl-Type set to ‘typeD’ in the joint TCI state.

Some implementations of the method and apparatuses described herein may further include: NE2 sends, to UE2, a configuration of a CLI reporting, where the configuration indicates a plurality of resources for CLI measurements; NE2 sends, to UE2, an indication of a timing offset to apply when performing the CLI measurements; UE2 applies the timing offset when performing the CLI measurements on the plurality of resources; UE2 sends, to NE2, a CLI report including a CLI measurement result based on the CLI measurements.

In some implementations of the method and apparatuses described herein, UE2 applies the timing offset with respect to a reference point in time, e.g., a reception time of an SSB from NE2. Additionally or alternatively, the reference point is a reception time of an SSB from NE1. Additionally or alternatively, NE1 or NE2 obtain the timing offset based on one or both of parameters or propagation delays by exchanging information of at least one of one or both of UE1 or UE2 locations, one or both of UE1 or UE2 TA offset, one or both of NE1 or NE2 location, and the like. Additionally or alternatively, NE2 receives an indication of the timing offset from NE1 via a backhaul or via an OTA signaling, where NE1 obtains an estimate for the indication based on one or more of: its own location obtained by GPS/GNSS or via OAM; the location of NE2 obtained by GPS/GNSS and then shared with NE1 by signaling or via OAM; an approximate location of UE1 obtained by a TA-based location estimation at NE1 or other positioning methods; or an approximate location of UE2 obtained based on the knowledge that UE2 is located at a cell edge of NE2, based on the knowledge that NE2 is a small cell network entity with a relatively small coverage area, or the like. Additionally or alternatively, NE2 obtains an estimate of the timing offset based on one or more of: its own location obtained by GPS/GNSS or via OAM; the location of NE1 obtained by GPS/GNSS and then shared with NE2 by signaling or via OAM; an approximate location of UE2 obtained by a TA-based location estimation at NE2 or other positioning methods; or an approximate location of UE1 obtained based on the knowledge that UE1 is located at a cell edge of NE1, based on the knowledge that NE1 is a small cell network entity with a relatively small coverage area, or the like. Additionally or alternatively, NE2 obtains an estimate of the timing offset based on one or more of: its own location; the location of NE1; an approximate location of UE2; or an approximate location of UE1 obtained by NE1 by a TA-based location estimation or other positioning methods, and then indicated to NE2 via a backhaul or via an OTA signaling. Additionally or alternatively, the CLI measurement result is an SRS-RSRP, CLI-RSSI, or the like.

Some implementations of the method and apparatuses described herein may further include: NE1 configures one or multiple SRS for a plurality of UE1s in a location region; NE1 indicates information of the SRS configuration and the associated location region to NE2; NE2 configures one or multiple CLI reporting configurations for UE2; NE2 uses the information (indicated by NE1) to indicate a timing offset to UE2; UE2 applies the indicated timing offset when measuring the CLI according to the one or multiple CLI reporting configurations.

In some implementations of the method and apparatuses described herein, if UE2 leaves the geographical area, NE2 indicates a new value of SRS Rx offset, unconfigures the associated CLI reporting, or takes a similar action. Additionally or alternatively, the geographical region is indicated by at least one of one or both of center coordinates or a radius, vertices of a polygon, or the like. Additionally or alternatively, NE2 indicates a center location or region associated with the transmission point(s) of the SRS. Then, if UE2 moves from one location to another, UE2 acquires an estimate of its own location and uses it to compute an timing offset to apply when measuring the CLI.

Some implementations of the method and apparatuses described herein may further include: NE2 sends, to UE2, a configuration of a CLI reporting, where the configuration indicates a plurality of resources for CLI measurements; NE2 sends, to UE2, an indication of multiple timing offsets to apply when performing the CLI measurements; UE2 applies the multiple timing offsets when performing the CLI measurements on the plurality of resources; UE2 obtains multiple CLI measurement results associated with the multiple timing offsets; UE2 sends, to NE2, a CLI report including based on the multiple CLI measurement results.

In some implementations of the method and apparatuses described herein, the CLI report comprises a CLI value equal to the maximum (worst-case) of the multiple CLI measurement results. Additionally or alternatively, the CLI report comprises a CLI value equal to the minimum (best-case) of the multiple CLI measurement results. Additionally or alternatively, the CLI report comprises a CLI value equal to the average or weighted average of the multiple CLI measurement results. Additionally or alternatively, the CLI report comprises the multiple CLI measurement results. Additionally or alternatively, the CLI report comprises a subset of the multiple CLI measurement results. Additionally or alternatively, the subset comprises a number of largest of the multiple CLI measurement results. Additionally or alternatively, the subset comprises a number of smallest of the multiple CLI measurement results. Additionally or alternatively, each CLI measurement result in the subset is an average or a weighted average of one or multiple of the multiple CLI measurement results. Additionally or alternatively, each of the CLI measurement results is an SRS-RSRP, CLI-RSSI, or the like.

Some implementations of the method and apparatuses described herein may further include: NE1 sends, to UE1, an SRS configuration, where the configuration indicates a plurality of resources for transmitting the SRS; NE1 sends, to UE1, an indication of a timing offset to apply when transmitting the SRS; UE1 applies the timing offset when transmitting the SRS.

In some implementations of the method and apparatuses described herein, UE1 applies the timing offset with respect to a reference point in time, e.g., an uplink transmission time according to an indicated TA. Additionally or alternatively, UE1 applies the timing offset with respect to a reference point in time, e.g., a reception time of an SSB from NE2. Additionally or alternatively, NE1 or NE2 obtain the timing offset based on one or both of parameters or propagation delays by exchanging information of at least one of one or both of UE1 or UE2 locations, one or both of UE1 or UE2 TA offset, one or both of NE1 or NE2 location, and the like. Additionally or alternatively, NE1 receives an indication of the timing offset from NE2 via a backhaul or via an OTA signaling, where NE2 obtain an estimate for the indication based on one or more of: its own location obtained by GPS/GNSS or via OAM; the location of NE1 obtained by GPS/GNSS and then shared with NE2 by signaling or via OAM; an approximate location of UE2 obtained by a TA-based location estimation at NE2 or other positioning methods; or an approximate location of UE1 obtained based on the knowledge that UE1 is located at a cell edge of NE1, based on the knowledge that NE1 is a small cell BS with a relatively small coverage area, or the like. Additionally or alternatively, NE1 obtains an estimate of the timing offset based on: its own location obtained by GPS/GNSS or via OAM; the location of NE2 obtained by GPS/GNSS and then shared with NE1 by signaling or via OAM; an approximate location of UEL obtained by a TA-based location estimation at NE1 or other positioning methods; or an approximate location of UE2 obtained based on the knowledge that UE2 is located at a cell edge of NE2, based on the knowledge that NE2 is a small cell BS with a relatively small coverage area, or the like. Additionally or alternatively, NE1 obtains an estimate of the timing offset based on one or more of: its own location; the location of NE2; an approximate location of UE1; or an approximate location of UE2 obtained by NE2 by a TA-based location estimation or other positioning methods and then indicated to NE1 via a backhaul or via an OTA signaling.

Some implementations of the method and apparatuses described herein may further include: NE1 configures an SRS for UE1 in a location region; NE1 indicates a timing offset associated with the location region; UE1 obtains an estimate of its own location; If UE1 determines that the estimate of its own location is in the location region, UE1 applies the associated timing offset when transmitting the SRS.

In some implementations of the method and apparatuses described herein, if UE1 leaves the location region, NE1 may indicate a new value of the timing offset, unconfigure the SRS transmission, or take a similar action. Additionally or alternatively, the geographical region is indicated by at least one of one or both of center coordinates or a radius, vertices of a polygon, or the like. Additionally or alternatively, NE1 indicates a center location or region associated with CLI measurement point(s). Then, if UE1 moves from one location to another, UE1 acquires an estimate of its own location and uses it to compute a timing offset to apply when transmitting the SRS.

Some implementations of the method and apparatuses described herein may further include: UE1 establishes a dual connection (DC) with NE1 and NE2; NE1 sends a configuration of SRS to UE1; NE2 indicates to UE1 a timing offset to apply when transmitting the SRS; UE1 applies the timing offset for transmitting SRS.

In some implementations of the method and apparatuses described herein, UE2 establishes a dual connection (DC) with NE1 and NE2. Additionally or alternatively, NE2 sends a configuration of a CLI reporting to UE2. Additionally or alternatively, NE1 indicates to UE2 a timing offset to apply when performing a CLI measurement in accordance with the CLI reporting. Additionally or alternatively, UE2 applies the timing offset when performing a CLI measurement to obtain a CLI measurement result. Additionally or alternatively, UE2 sends a CLI report to one or both of NE1 or NE2, where the CLI report comprises the CLI measurement result.

Some implementations of the method and apparatuses described herein may further include: NE1 configures a reference signal for UE1, where the reference signal configuration comprises information of a synchronization signal sequence, a synchronization signal identifier, a phase rotation, or the like; NE1 sends a message to NE2, where the message comprises information of the synchronization signal sequence, the synchronization signal identifier, the phase rotation, or the like; NE2 configures a timing acquisition and CLI reporting for UE2 based on the information in the message; UE1 transmits the reference signal in accordance with the reference signal configuration; UE2 receives the reference signal and acquires a reception timing according with the timing acquisition configuration; UE2 uses the reception timing to perform a CLI measurement and obtain a CLI measurement result in accordance with the CLI reporting configuration; UE2 sends a CLI report to NE2, where the CLI report comprises the CLI measurement result.

In some implementations of the method and apparatuses described herein, the CLI measurement result is an SRS-RSRP, CLI-RSSI, or the like.

In some implementations of the method and apparatuses described herein, an expiration timer is configured for the timing offset. Then one or both of UEL or UE2 applies the timing offset as long as the associated expiration timer has not reached zero.

In some implementations of the method and apparatuses described herein, a validity duration is indicated for the timing offset. Then one or both of UEL or UE2 applies the timing offset during the validity duration.

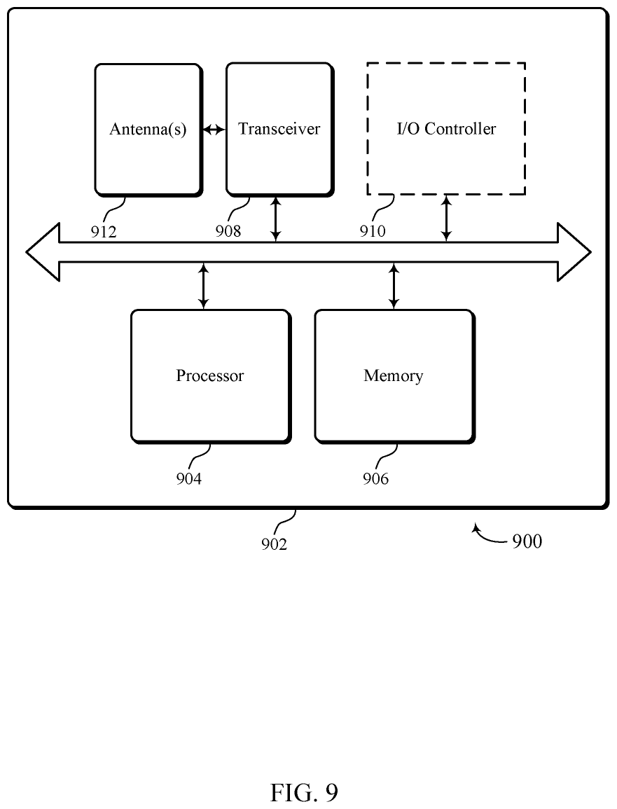

FIG. 9 illustrates an example of a block diagram 900 of a device 902 that supports interference measurement timing adjustment in accordance with aspects of the present disclosure. The device 902 may be an example of a UE 104 as described herein. The device 902 may also be referred to as an apparatus. The device 902 may support wireless communication with one or more network entities 102, UEs 104, or any combination thereof. The device 902 may include components for bi-directional communications including components for transmitting and receiving communications, such as a processor 904, a memory 906, a transceiver 908, and an I/O controller 910. These components may be in electronic communication or otherwise coupled (e.g., operatively, communicatively, functionally, electronically, electrically) via one or more interfaces (e.g., buses).

The processor 904, the memory 906, the transceiver 908, or various combinations thereof or various components thereof may be examples of means for performing various aspects of the present disclosure as described herein. For example, the processor 904, the memory 906, the transceiver 908, or various combinations or components thereof may support a method for performing one or more of the operations described herein.

In some implementations, the processor 904, the memory 906, the transceiver 908, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 904 and the memory 906 coupled with the processor 904 may be configured to perform one or more of the functions described herein (e.g., executing, by the processor 904, instructions stored in the memory 906).

For example, the processor 904 may support wireless communication at the device 902 in accordance with examples as disclosed herein. Processor 904 may be configured as or otherwise support to: receive, from a network entity, a first signaling indicating a configuration of a CLI reporting that indicates one or more resources for CLI measurements; obtain a timing offset to apply when performing the CLI measurements; apply, while performing a CLI measurement on the one or more resources, the timing offset with respect to a reference point in time; transmit, to the network entity, a second signaling indicating a CLI report that includes a result of the CLI measurement.

Additionally or alternatively, the processor 904 may be configured to or otherwise support: where the reference point is a reception time of a SSB from the network entity; where the result of the CLI measurement is a SRS-RSRP or a CLI-RSSI; where the processor is configured to: obtain an estimate of a location of the apparatus; and for each resource in the one or more resources: determine a location region associated with the resource; compute a distance between the estimate and the location region; and compute the timing offset based on the distance; where the processor is configured to cause the apparatus to receive, from the network entity in response to the apparatus leaving a location region, a third signaling indicating a new timing offset or unconfiguring the CLI reporting; where the timing offset is determined based on whether the apparatus is located in a location region, and the location region is indicated by one or more of center coordinates, a radius, or vertices of a polygon; where the processor is configured to cause the apparatus to, in response to the apparatus leaving a location region: obtain an estimate of a location of the apparatus; and compute, based on the location, a new timing offset to apply while performing the CLI measurement; where to obtain the timing offset is to receive, from the network entity, a third signaling indicating multiple timing offsets, and the processor is configured to cause the apparatus to: apply the multiple timing offsets when performing the CLI measurements on the one or more resources; obtain multiple CLI measurement results associated with the multiple timing offsets, where the CLI report is based on the multiple CLI measurement results; where the CLI report comprises a CLI value equal to a maximum CLI measurement result of the multiple CLI measurement results; where the CLI report comprises a CLI value equal to a minimum CLI measurement result of the multiple CLI measurement results; where the CLI report comprises a CLI value equal to an average or a weighted average of the multiple CLI measurement results; where the CLI report comprises the multiple CLI measurement results; where the CLI report comprises a subset of the multiple CLI measurement results; where the subset of the multiple CLI measurement results comprises a number of largest CLI measurement results of the multiple CLI measurement results; where the subset comprises a number of smallest CLI measurement results of the multiple CLI measurement results; where each of the CLI measurement results in the subset is an average or a weighted average of one or more of the multiple CLI measurement results; where each of the multiple CLI measurement results is a SRS-RSRP or a CLI-RSSI; where the processor is configured to cause the apparatus to apply the timing offset for as long as a countdown expiration timer associated with the timing offset has not reached zero; where the processor is configured to cause the apparatus to apply the timing offset for a validity duration associated with the timing offset; where the apparatus comprises a UE.

For example, the processor 904 may support wireless communication at the device 902 in accordance with examples as disclosed herein. Processor 904 may be configured as or otherwise support to: receive, from a network entity, a first signaling indicating a SRS configuration for a CLI measurement; receive, from the network entity, a second signaling indicating a timing offset to apply when transmitting the SRS; apply, while transmitting the SRS, the timing offset.

Additionally or alternatively, the processor 904 may be configured to or otherwise support: where to apply the timing offset is to apply the timing offset with respect to a reference point in time; where the reference point comprises an uplink transmission time according to an indicated TA; where the reference point comprises a reception time of a SSB from a network entity; where the processor is configured to cause the apparatus to: obtain an estimate of a location of the apparatus; determine a location region based on the estimate; determine one or more resources associated with the location region; and transmit the SRS, according to the SRS configuration for the CLI measurement, on the one or more resources; where the timing offset is associated with a location region and the processor is configured to cause the apparatus to: obtain an estimate of a location of the apparatus; and apply, in response to determining that the location of the apparatus is within the location region, the timing offset while transmitting the SRS; where the processor is configured to cause the apparatus to receive, from the network entity in response to the apparatus leaving a location region, a third signaling indicating a new timing offset or unconfiguring CLI reporting; where the timing offset is determined based on whether the apparatus is located in a location region, and the location region is indicated by one or more of center coordinates, a radius, or vertices of a polygon; where the processor is configured to cause the apparatus to, in response to the apparatus leaving a location region: obtain an estimate of a location of the apparatus; and compute, based on the location, a new timing offset to apply while performing the CLI measurement; where the processor is configured to cause the apparatus to: receive, from the network entity, a third signaling indicating a configuration for a reference signal, where the reference signal comprises a synchronization signal sequence, a synchronization signal identifier, or a phase rotation; and transmit, to a UE, a fourth signaling in accordance with the configuration for the reference signal; where the processor is configured to cause the apparatus to apply the timing offset for as long as a countdown expiration timer associated with the timing offset has not reached zero; where the processor is configured to cause the apparatus to apply the timing offset for a validity duration associated with the timing offset; where the apparatus comprises a UE.

For example, the processor 904 may support wireless communication at the device 902 in accordance with examples as disclosed herein. Processor 904 may be configured as or otherwise support a means for: receiving, from a network entity, a first signaling indicating a configuration of a CLI reporting that indicates one or more resources for CLI measurements; obtaining a timing offset to apply when performing the CLI measurements; applying, while performing a CLI measurement on the one or more resources, the timing offset with respect to a reference point in time; and transmitting, to the network entity, a second signaling indicating a CLI report that includes a result of the CLI measurement.

Additionally or alternatively, the processor 904 may be configured to or otherwise support: where the reference point is a reception time of a SSB from the network entity; where the result of the CLI measurement is a SRS-RSRP or a CLI-RSSI; further including: obtaining an estimate of a location of an apparatus implementing the method; and for each resource in the one or more resources: determining a location region associated with the resource; computing a distance between the estimate and the location region; and computing the timing offset based on the distance; further including receiving, from the network entity in response to an apparatus implementing the method leaving a location region, a third signaling indicating a new timing offset or unconfiguring the CLI reporting; where the timing offset is determined based on whether an apparatus implementing the method is located in a location region, and the location region is indicated by one or more of center coordinates, a radius, or vertices of a polygon; further including, in response to an apparatus implementing the method leaving a location region: obtaining an estimate of a location of the apparatus; and computing, based on the location, a new timing offset to apply while performing the CLI measurement; where obtaining the timing offset comprises receiving, from the network entity, a third signaling indicating multiple timing offsets, and further including: applying the multiple timing offsets when performing the CLI measurements on the one or more resources; and obtaining multiple CLI measurement results associated with the multiple timing offsets, where the CLI report is based on the multiple CLI measurement results; where the CLI report comprises a CLI value equal to a maximum CLI measurement result of the multiple CLI measurement results; where the CLI report comprises a CLI value equal to a minimum CLI measurement result of the multiple CLI measurement results; where the CLI report comprises a CLI value equal to an average or a weighted average of the multiple CLI measurement results; where the CLI report comprises the multiple CLI measurement results; where the CLI report comprises a subset of the multiple CLI measurement results; where the subset of the multiple CLI measurement results comprises a number of largest CLI measurement results of the multiple CLI measurement results; where the subset comprises a number of smallest CLI measurement results of the multiple CLI measurement results; where each of the CLI measurement results in the subset is an average or a weighted average of one or more of the multiple CLI measurement results; where each of the multiple CLI measurement results is a SRS-RSRP or a CLI-RSSI; further including applying the timing offset for as long as a countdown expiration timer associated with the timing offset has not reached zero; further including applying the timing offset for a validity duration associated with the timing offset; where an apparatus implementing the method comprises a UE.

For example, the processor 904 may support wireless communication at the device 902 in accordance with examples as disclosed herein. Processor 904 may be configured as or otherwise support a means for: receiving, from a network entity, a first signaling indicating a SRS configuration for a CLI measurement; receiving, from the network entity, a second signaling indicating a timing offset to apply when transmitting the SRS; and applying, while transmitting the SRS, the timing offset.

Additionally or alternatively, the processor 904 may be configured to or otherwise support: where applying the timing offset comprises applying the timing offset with respect to a reference point in time; where the reference point comprises an uplink transmission time according to an indicated TA; where the reference point comprises a reception time of a SSB from a network entity; further including: obtaining an estimate of a location of an apparatus implementing the method; determining a location region based on the estimate; determining one or more resources associated with the location region; and transmitting the SRS, according to the SRS configuration for the CLI measurement, on the one or more resources; where the timing offset is associated with a location region and further including: obtaining an estimate of a location of an apparatus implementing the method; and applying, in response to determining that the location of the apparatus is within the location region, the timing offset while transmitting the SRS; further including receiving, from the network entity in response to an apparatus implementing the method leaving a location region, a third signaling indicating a new timing offset or unconfiguring CLI reporting; where the timing offset is determined based on whether an apparatus implementing the method is located in a location region, and the location region is indicated by one or more of center coordinates, a radius, or vertices of a polygon; further including, in response to an apparatus implementing the method leaving a location region: obtaining an estimate of a location of the apparatus; and computing, based on the location, a new timing offset to apply while performing the CLI measurement; further including: receiving, from the network entity, a third signaling indicating a configuration for a reference signal, where the reference signal comprises a synchronization signal sequence, a synchronization signal identifier, or a phase rotation; and transmitting, to a UE, a fourth signaling in accordance with the configuration for the reference signal; further including applying the timing offset for as long as a countdown expiration timer associated with the timing offset has not reached zero; further including applying the timing offset for a validity duration associated with the timing offset; where an apparatus implementing the method comprises a UE.

For example, the processor 904 of the device 902, such as a UE 104, may support wireless communication in accordance with examples as disclosed herein. The processor 904 includes at least one controller coupled with at least one memory, and is configured to or operable to cause the processor to receive, from a network entity, a first signaling indicating a configuration of a CLI reporting that indicates one or more resources for CLI measurements; obtain a timing offset to apply when performing the CLI measurements; apply, while performing a CLI measurement on the one or more resources, the timing offset with respect to a reference point in time; and transmit, to the network entity, a second signaling indicating a CLI report that includes a result of the CLI measurement.

For example, the processor 904 of the device 902, such as a UE 104, may support wireless communication in accordance with examples as disclosed herein. The processor 904 includes at least one controller coupled with at least one memory, and is configured to or operable to cause the processor to receive, from a network entity, a first signaling indicating a SRS configuration for a CLI measurement; receive, from the network entity, a second signaling indicating a timing offset to apply when transmitting the SRS; and apply, while transmitting the SRS, the timing offset.

The processor 904 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 904 may be configured to operate a memory array using a memory controller. In some other implementations, a memory controller may be integrated into the processor 904. The processor 904 may be configured to execute computer-readable instructions stored in a memory (e.g., the memory 906) to cause the device 902 to perform various functions of the present disclosure.

The memory 906 may include random access memory (RAM) and read-only memory (ROM). The memory 906 may store computer-readable, computer-executable code including instructions that, when executed by the processor 904 cause the device 902 to perform various functions described herein. The code may be stored in a non-transitory computer-readable medium such as system memory or another type of memory. In some implementations, the code may not be directly executable by the processor 904 but may cause a computer (e.g., when compiled and executed) to perform functions described herein. In some implementations, the memory 906 may include, among other things, a basic I/O system (BIOS) which may control basic hardware or software operation such as the interaction with peripheral components or devices.

The I/O controller 910 may manage input and output signals for the device 902. The I/O controller 910 may also manage peripherals not integrated into the device 902. In some implementations, the I/O controller 910 may represent a physical connection or port to an external peripheral. In some implementations, the I/O controller 910 may utilize an operating system such as iOS®, ANDROID®, MS-DOS®, MS-WINDOWS®, OS/2®, UNIX®, LINUX®, or another known operating system. In some implementations, the I/O controller 910 may be implemented as part of a processor, such as the processor 904. In some implementations, a user may interact with the device 902 via the I/O controller 910 or via hardware components controlled by the I/O controller 910.

In some implementations, the device 902 may include a single antenna 912. However, in some other implementations, the device 902 may have more than one antenna 912 (i.e., multiple antennas), including multiple antenna panels or antenna arrays, which may be capable of concurrently transmitting or receiving multiple wireless transmissions. The transceiver 908 may communicate bi-directionally, via the one or more antennas 912, wired, or wireless links as described herein. For example, the transceiver 908 may represent a wireless transceiver and may communicate bi-directionally with another wireless transceiver. The transceiver 908 may also include a modem to modulate the packets, to provide the modulated packets to one or more antennas 912 for transmission, and to demodulate packets received from the one or more antennas 912.

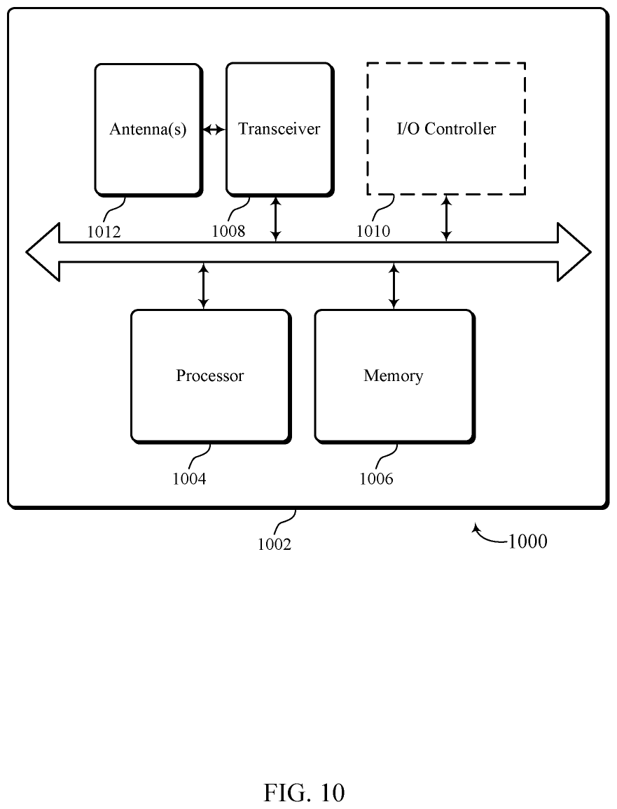

FIG. 10 illustrates an example of a block diagram 1000 of a device 1002 that supports interference measurement timing adjustment in accordance with aspects of the present disclosure. The device 1002 may be an example of a network entity 102 as described herein. The device 1002 may also be referred to as an apparatus. The device 1002 may support wireless communication with one or more network entities 102, UEs 104, or any combination thereof. The device 1002 may include components for bi-directional communications including components for transmitting and receiving communications, such as a processor 1004, a memory 1006, a transceiver 1008, and an I/O controller 1010. These components may be in electronic communication or otherwise coupled (e.g., operatively, communicatively, functionally, electronically, electrically) via one or more interfaces (e.g., buses).

The processor 1004, the memory 1006, the transceiver 1008, or various combinations thereof or various components thereof may be examples of means for performing various aspects of the present disclosure as described herein. For example, the processor 1004, the memory 1006, the transceiver 1008, or various combinations or components thereof may support a method for performing one or more of the operations described herein.

In some implementations, the processor 1004, the memory 1006, the transceiver 1008, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1004 and the memory 1006 coupled with the processor 1004 may be configured to perform one or more of the functions described herein (e.g., executing, by the processor 1004, instructions stored in the memory 1006).

For example, the processor 1004 may support wireless communication at the device 1002 in accordance with examples as disclosed herein. Processor 1004 may be configured as or otherwise support to: receive, from a first network entity, a first signaling indicating a configuration of one or more resources for a CLI measurement; transmit, to a UE, a second signaling indicating a configuration of a CLI reporting that indicates the one or more resources and a timing offset for the UE to apply when performing the CLI measurements; and receive, from the UE, a third signaling indicating a CLI report including a result of the CLI measurements.

Additionally or alternatively, the processor 1004 may be configured to or otherwise support: where the processor is configured to cause the apparatus to obtain the timing offset based on one or both of parameters or propagation delays by exchanging information regarding at least one of: a location of the UE or a location of an aggressor UE, a TA of the UE or a TA of the aggressor UE, or a location of the apparatus or a location of the network entity; where the processor is configured to cause the apparatus to receive, from the first network entity, a fourth signaling indicating the timing offset, where the fourth signaling comprises a backhaul signaling or an OTA signaling, where the timing offset is based on at least one of: a location of the network entity location obtained via a GPS, a GNSS, or an OAM; a location of the apparatus obtained via GPS or GNSS and shared with the network entity or via OAM; an approximate location of an aggressor UE obtained by a TA based location estimation at the network entity; or an approximate location of the UE obtained based on knowledge that the UE is located at a cell edge of the apparatus or that the apparatus has a small cell coverage area; where the processor is configured to cause the apparatus to obtain an estimate of the timing offset based on at least one of: a location of the apparatus obtained via a GPS, a GNSS, or an OAM; a location of the network entity obtained by the network entity via GPS or GNSS and shared with the apparatus or via OAM; an approximate location of the UE obtained by a TA based location estimation at the apparatus; or an approximate location of an aggressor UE obtained based on knowledge that the aggressor UE is located at a cell edge of the network entity or that the network entity has a small cell coverage area; where the processor is configured to cause the apparatus to obtain an estimate of the timing offset based on at least one of: a location of the apparatus; a location of the network entity; an approximate location of the UE; or an approximate location of an aggressor UE obtained by the network entity and indicated to the network entity via a backhaul signaling or an OTA signaling; where the results of the CLI measurements are a SRS-RSRP or a CLI-RSSI; where the processor is configured to cause the apparatus to transmit, to the UE in response to the UE leaving a location region, a fourth signaling indicating a new timing offset or unconfiguring the CLI reporting; where the timing offset is determined based on whether the UE is located in a location region, and the location region is indicated by one or more of center coordinates, a radius, or vertices of a polygon; where the processor is configured to cause the apparatus to transmit, to the UE, a fourth signaling indicating that the UE is to apply the timing offset for as long as a countdown expiration timer associated with the timing offset has not reached zero; where the processor is configured to cause the apparatus to transmit, to the UE, a fourth signaling indicating that the UE is to apply the timing offset for a validity duration associated with the timing offset; where the apparatus comprises a base station or a NG-RAN node.

For example, the processor 1004 may support wireless communication at the device 1002 in accordance with examples as disclosed herein. Processor 1004 may be configured as or otherwise support to: transmit, to a UE, a first signaling indicating a configuration of a SRS for a CLI measurement, where the configuration indicates one or more resources each of which is associated with one of multiple location regions; and transmit, to a network entity, a second signaling indicating the configuration.

Additionally or alternatively, the processor 1004 may be configured to or otherwise support: where the processor is configured to cause the apparatus to transmit, to the UE, a third signaling indicating a timing offset for the UE to apply when transmitting the SRS; where the processor is configured to cause the apparatus to obtain the timing offset based on one or both of parameters or propagation delays by exchanging information regarding at least one of: a location of the UE or a location of a victim UE, a TA of the UE or a TA of the victim UE, or a location of the apparatus or a location of the network entity; where the processor is configured to cause the apparatus to receive, from the first network entity, a third signaling indicating the timing offset, where the third signaling comprises a backhaul signaling or an OTA signaling, where the timing offset is based on at least one of: a location of the apparatus obtained via a GPS, a GNSS, or an OAM; a location of the apparatus obtained via GPS or GNSS and shared with the network entity or via OAM; an approximate location of a victim UE obtained by a TA based location estimation at the network entity; or an approximate location of the UE obtained based on knowledge that the UE is located at a cell edge of the apparatus or that the apparatus has a small cell coverage area; where the processor is configured to cause the apparatus to obtain an estimate of the timing offset based on at least one of: a location of the apparatus obtained via a GPS, a GNSS, or an OAM; a location of the network entity obtained by the network entity via GPS or GNSS and shared with the apparatus or via OAM; an approximate location of the UE obtained by a TA based location estimation at the apparatus; or an approximate location of a victim UE obtained based on knowledge that the victim UE is located at a cell edge of the network entity or that the network entity has a small cell coverage area; where the processor is configured to cause the apparatus to obtain an estimate of the timing offset based on at least one of: a location of the apparatus; a location of the network entity; an approximate location of the UE; or an approximate location of a victim UE obtained by the network entity and indicated to the network entity via a backhaul signaling or an OTA signaling; where the processor is configured to cause the apparatus to transmit, to the UE, a third signaling indicating a timing offset associated with one location region of the multiple location regions for the UE to apply when transmitting the SRS while located in the location region; where the processor is configured to cause the apparatus to transmit, to the UE in response to the UE leaving the one location region, a fourth signaling indicating a new timing offset or unconfiguring CLI reporting; where the one location region is indicated by one or more of center coordinates, a radius, or vertices of a polygon; where the apparatus comprises a base station or a NG-RAN node.

For example, the processor 1004 may support wireless communication at the device 1002 in accordance with examples as disclosed herein. Processor 1004 may be configured as or otherwise support a means for: receiving, from a first network entity, a first signaling indicating a configuration of one or more resources for a CLI measurement; transmitting, to a UE, a second signaling indicating a configuration of a CLI reporting that indicates the one or more resources and a timing offset for the UE to apply when performing the CLI measurements; and receiving, from the UE, a third signaling indicating a CLI report including a result of the CLI measurements.

Additionally or alternatively, the processor 1004 may be configured to or otherwise support: further including obtaining the timing offset based on one or both of parameters or propagation delays by exchanging information regarding at least one of: a location of the UE or a location of an aggressor UE, a TA of the UE or a TA of the aggressor UE, or a location of an apparatus implementing the method or a location of the network entity; further including receiving, from the first network entity, a fourth signaling indicating the timing offset, where the fourth signaling comprises a backhaul signaling or an OTA signaling, where the timing offset is based on at least one of: a location of the network entity location obtained via a GPS, a GNSS, or an OAM; a location of an apparatus implementing the method obtained via GPS or GNSS and shared with the network entity or via OAM; an approximate location of an aggressor UE obtained by a TA based location estimation at the network entity; or an approximate location of the UE obtained based on knowledge that the UE is located at a cell edge of the apparatus or that the apparatus has a small cell coverage area; further including obtaining an estimate of the timing offset based on at least one of: a location of an apparatus implementing the method obtained via a GPS, a GNSS, or an OAM; a location of the network entity obtained by the network entity via GPS or GNSS and shared with the apparatus or via OAM; an approximate location of the UE obtained by a TA based location estimation at the apparatus; or an approximate location of an aggressor UE obtained based on knowledge that the aggressor UE is located at a cell edge of the network entity or that the network entity has a small cell coverage area; further including obtaining an estimate of the timing offset based on at least one of: a location of an apparatus implementing the method; a location of the network entity; an approximate location of the UE; or an approximate location of an aggressor UE obtained by the network entity and indicated to the network entity via a backhaul signaling or an OTA signaling; where the results of the CLI measurements are a SRS-RSRP or a CLI-RSSI; further including transmitting, to the UE in response to the UE leaving a location region, a fourth signaling indicating a new timing offset or unconfiguring the CLI reporting; where the timing offset is determined based on whether the UE is located in a location region, and the location region is indicated by one or more of center coordinates, a radius, or vertices of a polygon; further including transmitting, to the UE, a fourth signaling indicating that the UE is to apply the timing offset for as long as a countdown expiration timer associated with the timing offset has not reached zero; further including transmitting, to the UE, a fourth signaling indicating that the UE is to apply the timing offset for a validity duration associated with the timing offset; where an apparatus implementing the method comprises a base station or a NG-RAN node.

For example, the processor 1004 may support wireless communication at the device 1002 in accordance with examples as disclosed herein. Processor 1004 may be configured as or otherwise support a means for: transmitting, to a UE, a first signaling indicating a configuration of a SRS for a CLI measurement, where the configuration indicates one or more resources each of which is associated with one of multiple location regions; and transmitting, to a network entity, a second signaling indicating the configuration.

Additionally or alternatively, the processor 1004 may be configured to or otherwise support: further including transmitting, to the UE, a third signaling indicating a timing offset for the UE to apply when transmitting the SRS; further including obtaining the timing offset based on one or both of parameters or propagation delays by exchanging information regarding at least one of: a location of the UE or a location of a victim UE, a TA of the UE or a TA of the victim UE, or a location of an apparatus implementing the method or a location of the network entity; further including receiving, from the first network entity, a third signaling indicating the timing offset, where the third signaling comprises a backhaul signaling or an OTA signaling, where the timing offset is based on at least one of: a location of an apparatus implementing the method obtained via a GPS, a GNSS, or an OAM; a location of the apparatus obtained via GPS or GNSS and shared with the network entity or via OAM; an approximate location of a victim UE obtained by a TA based location estimation at the network entity; or an approximate location of the UE obtained based on knowledge that the UE is located at a cell edge of the apparatus or that the apparatus has a small cell coverage area; further including obtaining an estimate of the timing offset based on at least one of: a location of an apparatus implementing the method obtained via a GPS, a GNSS, or an OAM; a location of the network entity obtained by the network entity via GPS or GNSS and shared with the apparatus or via OAM; an approximate location of the UE obtained by a TA based location estimation at the apparatus; or an approximate location of a victim UE obtained based on knowledge that the victim UE is located at a cell edge of the network entity or that the network entity has a small cell coverage area; further including obtaining an estimate of the timing offset based on at least one of: a location of an apparatus implementing the method; a location of the network entity; an approximate location of the UE; or an approximate location of a victim UE obtained by the network entity and indicated to the network entity via a backhaul signaling or an OTA signaling; further including transmitting, to the UE, a third signaling indicating a timing offset associated with one location region of the multiple location regions for the UE to apply when transmitting the SRS while located in the location region; further including transmitting, to the UE in response to the UE leaving the one location region, a fourth signaling indicating a new timing offset or unconfiguring CLI reporting; where the one location region is indicated by one or more of center coordinates, a radius, or vertices of a polygon; where an apparatus implementing the method comprises a base station or a NG-RAN node.

The processor 1004 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1004 may be configured to operate a memory array using a memory controller. In some other implementations, a memory controller may be integrated into the processor 1004. The processor 1004 may be configured to execute computer-readable instructions stored in a memory (e.g., the memory 1006) to cause the device 1002 to perform various functions of the present disclosure.

The memory 1006 may include random access memory (RAM) and read-only memory (ROM). The memory 1006 may store computer-readable, computer-executable code including instructions that, when executed by the processor 1004 cause the device 1002 to perform various functions described herein. The code may be stored in a non-transitory computer-readable medium such as system memory or another type of memory. In some implementations, the code may not be directly executable by the processor 1004 but may cause a computer (e.g., when compiled and executed) to perform functions described herein. In some implementations, the memory 1006 may include, among other things, a basic I/O system (BIOS) which may control basic hardware or software operation such as the interaction with peripheral components or devices.

The I/O controller 1010 may manage input and output signals for the device 1002. The I/O controller 1010 may also manage peripherals not integrated into the device 1002. In some implementations, the I/O controller 1010 may represent a physical connection or port to an external peripheral. In some implementations, the I/O controller 1010 may utilize an operating system such as iOS®, ANDROID®, MS-DOS®, MS-WINDOWS®, OS/2®, UNIX®, LINUX®, or another known operating system. In some implementations, the I/O controller 1010 may be implemented as part of a processor, such as the processor 1004. In some implementations, a user may interact with the device 1002 via the I/O controller 1010 or via hardware components controlled by the I/O controller 1010.

In some implementations, the device 1002 may include a single antenna 1012. However, in some other implementations, the device 1002 may have more than one antenna 1012 (i.e., multiple antennas), including multiple antenna panels or antenna arrays, which may be capable of concurrently transmitting or receiving multiple wireless transmissions. The transceiver 1008 may communicate bi-directionally, via the one or more antennas 1012, wired, or wireless links as described herein. For example, the transceiver 1008 may represent a wireless transceiver and may communicate bi-directionally with another wireless transceiver. The transceiver 1008 may also include a modem to modulate the packets, to provide the modulated packets to one or more antennas 1012 for transmission, and to demodulate packets received from the one or more antennas 1012.

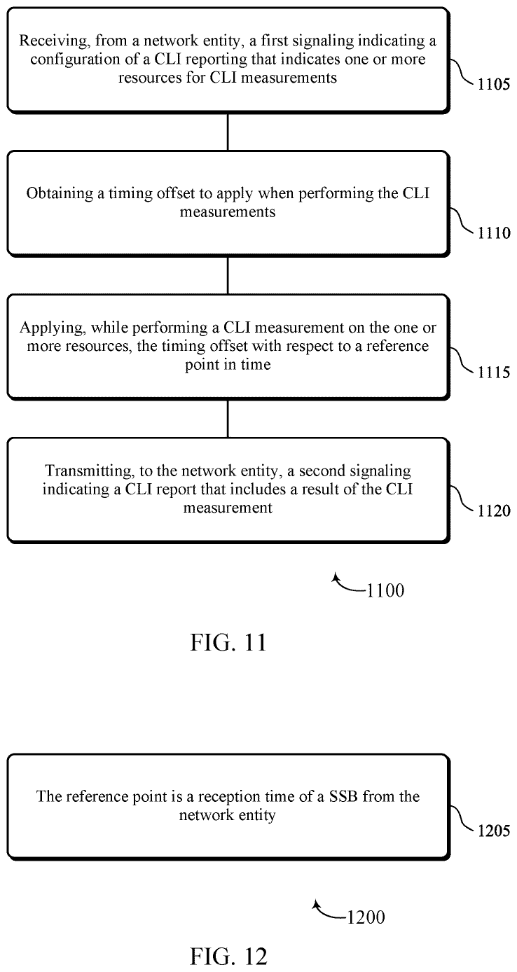

FIG. 11 illustrates a flowchart of a method 1100 that supports interference measurement timing adjustment in accordance with aspects of the present disclosure. The operations of the method 1100 may be implemented by a device or its components as described herein. For example, the operations of the method 1100 may be performed by a UE 104 as described with reference to FIGS. 1 through 10. In some implementations, the device may execute a set of instructions to control the function elements of the device to perform the described functions. Additionally, or alternatively, the device may perform aspects of the described functions using special-purpose hardware.

At 1105, the method may include receiving, from a network entity, a first signaling indicating a configuration of a CLI reporting that indicates one or more resources for CLI measurements. The operations of 1105 may be performed in accordance with examples as described herein. In some implementations, aspects of the operations of 1105 may be performed by a device as described with reference to FIG. 1.

At 1110, the method may include obtaining a timing offset to apply when performing the CLI measurements. The operations of 1110 may be performed in accordance with examples as described herein. In some implementations, aspects of the operations of 1110 may be performed by a device as described with reference to FIG. 1.

At 1115, the method may include applying, while performing a CLI measurement on the one or more resources, the timing offset with respect to a reference point in time. The operations of 1115 may be performed in accordance with examples as described herein. In some implementations, aspects of the operations of 1115 may be performed by a device as described with reference to FIG. 1.

At 1120, the method may include transmitting, to the network entity, a second signaling indicating a CLI report that includes a result of the CLI measurement. The operations of 1120 may be performed in accordance with examples as described herein. In some implementations, aspects of the operations of 1120 may be performed by a device as described with reference to FIG. 1.

FIG. 12 illustrates a flowchart of a method 1200 that supports interference measurement timing adjustment in accordance with aspects of the present disclosure. The operations of the method 1200 may be implemented by a device or its components as described herein. For example, the operations of the method 1200 may be performed by a UE 104 as described with reference to FIGS. 1 through 10. In some implementations, the device may execute a set of instructions to control the function elements of the device to perform the described functions. Additionally, or alternatively, the device may perform aspects of the described functions using special-purpose hardware.

At 1205, the method may include the reference point is a reception time of a SSB from the network entity. The operations of 1205 may be performed in accordance with examples as described herein. In some implementations, aspects of the operations of 1205 may be performed by a device as described with reference to FIG. 1.

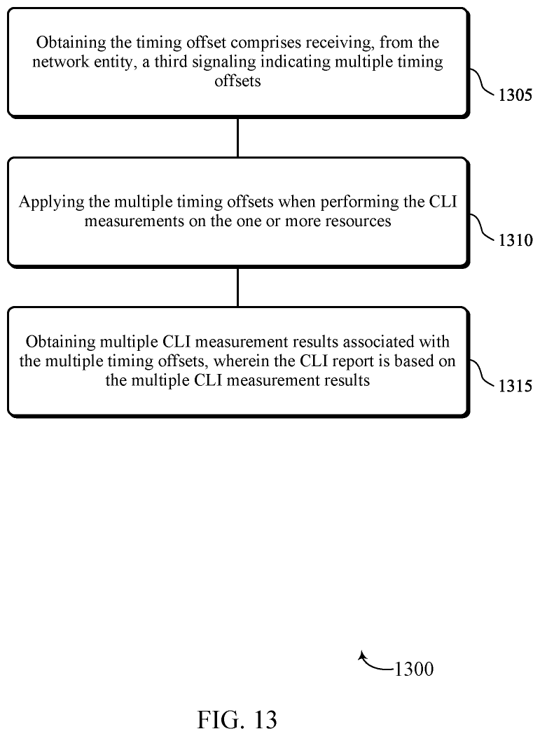

FIG. 13 illustrates a flowchart of a method 1300 that supports interference measurement timing adjustment in accordance with aspects of the present disclosure. The operations of the method 1300 may be implemented by a device or its components as described herein. For example, the operations of the method 1300 may be performed by a UE 104 as described with reference to FIGS. 1 through 10. In some implementations, the device may execute a set of instructions to control the function elements of the device to perform the described functions. Additionally, or alternatively, the device may perform aspects of the described functions using special-purpose hardware.

At 1305, the method may include obtaining the timing offset comprises receiving, from the network entity, a third signaling indicating multiple timing offsets. The operations of 1305 may be performed in accordance with examples as described herein. In some implementations, aspects of the operations of 1305 may be performed by a device as described with reference to FIG. 1.

At 1310, the method may include applying the multiple timing offsets when performing the CLI measurements on the one or more resources. The operations of 1310 may be performed in accordance with examples as described herein. In some implementations, aspects of the operations of 1310 may be performed by a device as described with reference to FIG. 1.

At 1315, the method may include obtaining multiple CLI measurement results associated with the multiple timing offsets, wherein the CLI report is based on the multiple CLI measurement results. The operations of 1315 may be performed in accordance with examples as described herein. In some implementations, aspects of the operations of 1315 may be performed by a device as described with reference to FIG. 1.

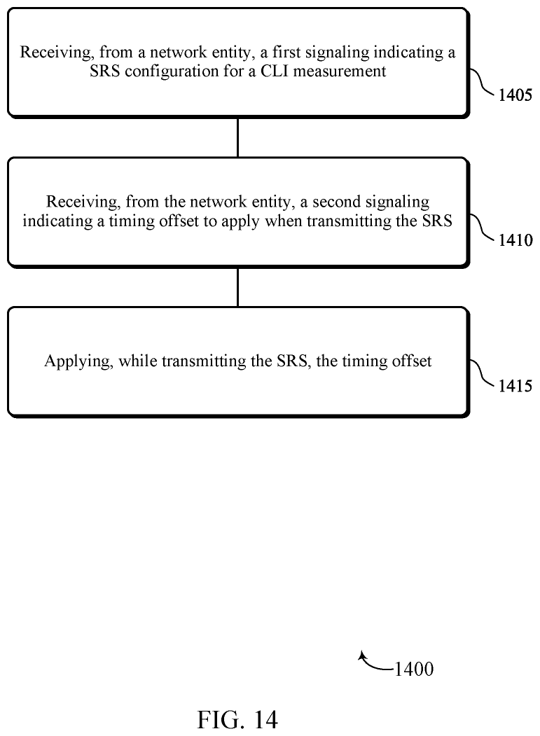

FIG. 14 illustrates a flowchart of a method 1400 that supports interference measurement timing adjustment in accordance with aspects of the present disclosure. The operations of the method 1400 may be implemented by a device or its components as described herein. For example, the operations of the method 1400 may be performed by a UE 104 as described with reference to FIGS. 1 through 10. In some implementations, the device may execute a set of instructions to control the function elements of the device to perform the described functions. Additionally, or alternatively, the device may perform aspects of the described functions using special-purpose hardware.

At 1405, the method may include receiving, from a network entity, a first signaling indicating a SRS configuration for a CLI measurement. The operations of 1405 may be performed in accordance with examples as described herein. In some implementations, aspects of the operations of 1405 may be performed by a device as described with reference to FIG. 1.

At 1410, the method may include receiving, from the network entity, a second signaling indicating a timing offset to apply when transmitting the SRS. The operations of 1410 may be performed in accordance with examples as described herein. In some implementations, aspects of the operations of 1410 may be performed by a device as described with reference to FIG. 1.

At 1415, the method may include applying, while transmitting the SRS, the timing offset. The operations of 1415 may be performed in accordance with examples as described herein. In some implementations, aspects of the operations of 1415 may be performed by a device as described with reference to FIG. 1.

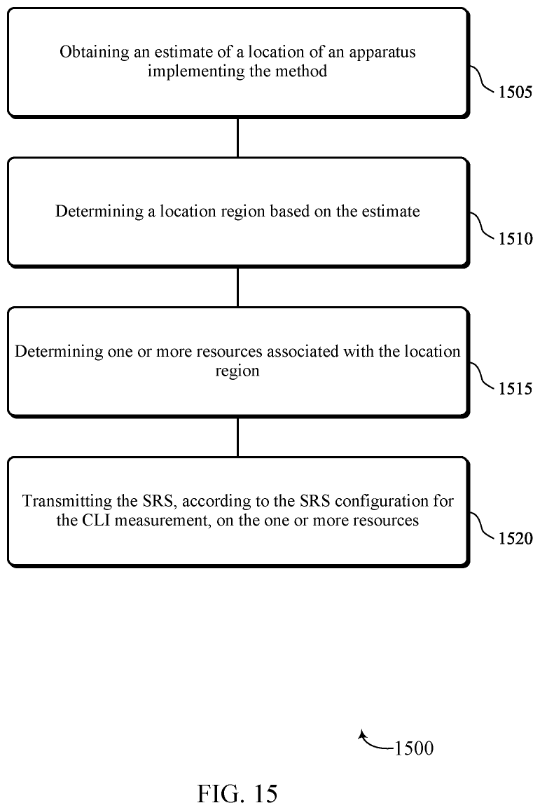

FIG. 15 illustrates a flowchart of a method 1500 that supports interference measurement timing adjustment in accordance with aspects of the present disclosure. The operations of the method 1500 may be implemented by a device or its components as described herein. For example, the operations of the method 1500 may be performed by a UE 104 as described with reference to FIGS. 1 through 10. In some implementations, the device may execute a set of instructions to control the function elements of the device to perform the described functions. Additionally, or alternatively, the device may perform aspects of the described functions using special-purpose hardware.

At 1505, the method may include obtaining an estimate of a location of an apparatus implementing the method. The operations of 1505 may be performed in accordance with examples as described herein. In some implementations, aspects of the operations of 1505 may be performed by a device as described with reference to FIG. 1.

At 1510, the method may include determining a location region based on the estimate. The operations of 1510 may be performed in accordance with examples as described herein. In some implementations, aspects of the operations of 1510 may be performed by a device as described with reference to FIG. 1.

At 1515, the method may include determining one or more resources associated with the location region. The operations of 1515 may be performed in accordance with examples as described herein. In some implementations, aspects of the operations of 1515 may be performed by a device as described with reference to FIG. 1.

At 1520, the method may include transmitting the SRS, according to the SRS configuration for the CLI measurement, on the one or more resources. The operations of 1520 may be performed in accordance with examples as described herein. In some implementations, aspects of the operations of 1520 may be performed by a device as described with reference to FIG. 1.

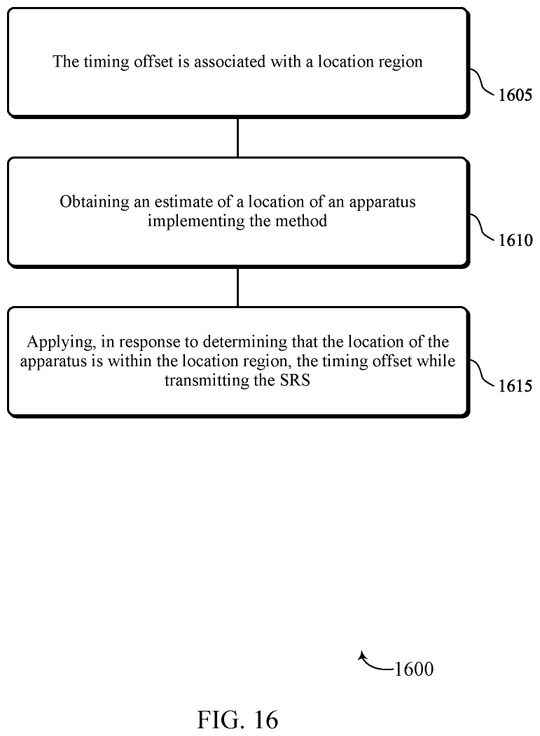

FIG. 16 illustrates a flowchart of a method 1600 that supports interference measurement timing adjustment in accordance with aspects of the present disclosure. The operations of the method 1600 may be implemented by a device or its components as described herein. For example, the operations of the method 1600 may be performed by a UE 104 as described with reference to FIGS. 1 through 10. In some implementations, the device may execute a set of instructions to control the function elements of the device to perform the described functions. Additionally, or alternatively, the device may perform aspects of the described functions using special-purpose hardware.

At 1605, the method may include the timing offset is associated with a location region. The operations of 1605 may be performed in accordance with examples as described herein. In some implementations, aspects of the operations of 1605 may be performed by a device as described with reference to FIG. 1.

At 1610, the method may include obtaining an estimate of a location of an apparatus implementing the method. The operations of 1610 may be performed in accordance with examples as described herein. In some implementations, aspects of the operations of 1610 may be performed by a device as described with reference to FIG. 1.

At 1615, the method may include applying, in response to determining that the location of the apparatus is within the location region, the timing offset while transmitting the SRS. The operations of 1615 may be performed in accordance with examples as described herein. In some implementations, aspects of the operations of 1615 may be performed by a device as described with reference to FIG. 1.

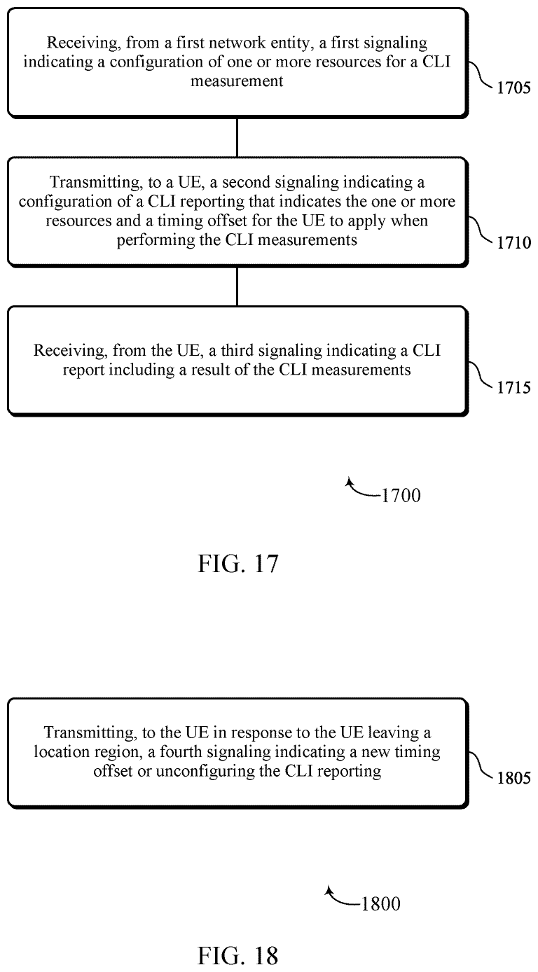

FIG. 17 illustrates a flowchart of a method 1700 that supports interference measurement timing adjustment in accordance with aspects of the present disclosure. The operations of the method 1700 may be implemented by a device or its components as described herein. For example, the operations of the method 1700 may be performed by a network entity 102 as described with reference to FIGS. 1 through 10. In some implementations, the device may execute a set of instructions to control the function elements of the device to perform the described functions. Additionally, or alternatively, the device may perform aspects of the described functions using special-purpose hardware.

At 1705, the method may include receiving, from a first network entity, a first signaling indicating a configuration of one or more resources for a CLI measurement. The operations of 1705 may be performed in accordance with examples as described herein. In some implementations, aspects of the operations of 1705 may be performed by a device as described with reference to FIG. 1.

At 1710, the method may include transmitting, to a UE, a second signaling indicating a configuration of a CLI reporting that indicates the one or more resources and a timing offset for the UE to apply when performing the CLI measurements. The operations of 1710 may be performed in accordance with examples as described herein. In some implementations, aspects of the operations of 1710 may be performed by a device as described with reference to FIG. 1.

At 1715, the method may include receiving, from the UE, a third signaling indicating a CLI report including a result of the CLI measurements. The operations of 1715 may be performed in accordance with examples as described herein. In some implementations, aspects of the operations of 1715 may be performed by a device as described with reference to FIG. 1.

FIG. 18 illustrates a flowchart of a method 1800 that supports interference measurement timing adjustment in accordance with aspects of the present disclosure. The operations of the method 1800 may be implemented by a device or its components as described herein. For example, the operations of the method 1800 may be performed by a network entity 102 as described with reference to FIGS. 1 through 10. In some implementations, the device may execute a set of instructions to control the function elements of the device to perform the described functions. Additionally, or alternatively, the device may perform aspects of the described functions using special-purpose hardware.

At 1805, the method may include transmitting, to the UE in response to the UE leaving a location region, a fourth signaling indicating a new timing offset or unconfiguring the CLI reporting. The operations of 1805 may be performed in accordance with examples as described herein. In some implementations, aspects of the operations of 1805 may be performed by a device as described with reference to FIG. 1.

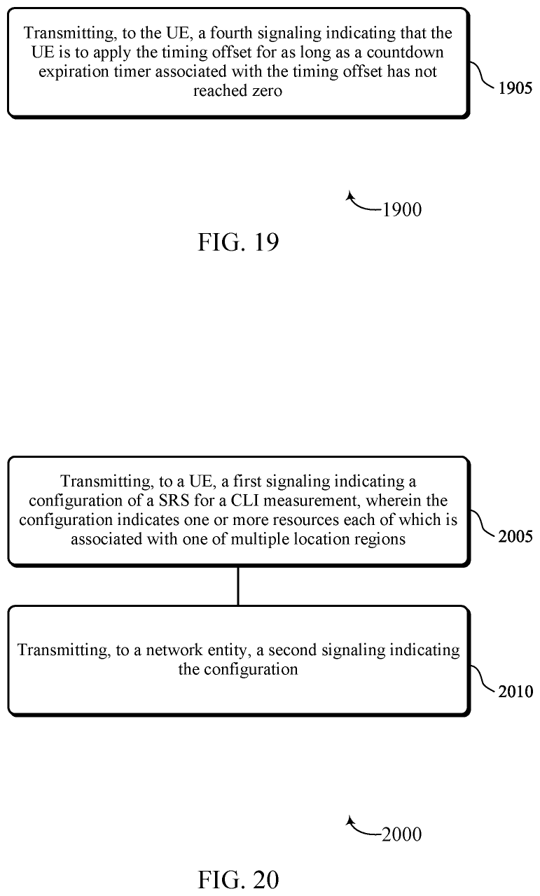

FIG. 19 illustrates a flowchart of a method 1900 that supports interference measurement timing adjustment in accordance with aspects of the present disclosure. The operations of the method 1900 may be implemented by a device or its components as described herein. For example, the operations of the method 1900 may be performed by a network entity 102 as described with reference to FIGS. 1 through 10. In some implementations, the device may execute a set of instructions to control the function elements of the device to perform the described functions. Additionally, or alternatively, the device may perform aspects of the described functions using special-purpose hardware.

At 1905, the method may include transmitting, to the UE, a fourth signaling indicating that the UE is to apply the timing offset for as long as a countdown expiration timer associated with the timing offset has not reached zero. The operations of 1905 may be performed in accordance with examples as described herein. In some implementations, aspects of the operations of 1905 may be performed by a device as described with reference to FIG. 1.

FIG. 20 illustrates a flowchart of a method 2000 that supports interference measurement timing adjustment in accordance with aspects of the present disclosure. The operations of the method 2000 may be implemented by a device or its components as described herein. For example, the operations of the method 2000 may be performed by a network entity 102 as described with reference to FIGS. 1 through 10. In some implementations, the device may execute a set of instructions to control the function elements of the device to perform the described functions. Additionally, or alternatively, the device may perform aspects of the described functions using special-purpose hardware.

At 2005, the method may include transmitting, to a UE, a first signaling indicating a configuration of a SRS for a CLI measurement, wherein the configuration indicates one or more resources each of which is associated with one of multiple location regions. The operations of 2005 may be performed in accordance with examples as described herein. In some implementations, aspects of the operations of 2005 may be performed by a device as described with reference to FIG. 1.

At 2010, the method may include transmitting, to a network entity, a second signaling indicating the configuration. The operations of 2010 may be performed in accordance with examples as described herein. In some implementations, aspects of the operations of 2010 may be performed by a device as described with reference to FIG. 1.

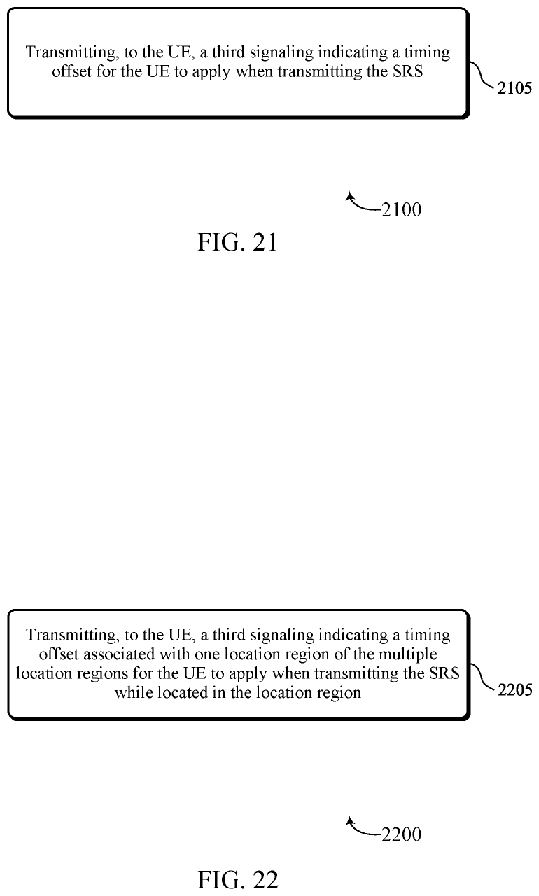

FIG. 21 illustrates a flowchart of a method 2100 that supports interference measurement timing adjustment in accordance with aspects of the present disclosure. The operations of the method 2100 may be implemented by a device or its components as described herein. For example, the operations of the method 2100 may be performed by a network entity 102 as described with reference to FIGS. 1 through 10. In some implementations, the device may execute a set of instructions to control the function elements of the device to perform the described functions. Additionally, or alternatively, the device may perform aspects of the described functions using special-purpose hardware.

At 2105, the method may include transmitting, to the UE, a third signaling indicating a timing offset for the UE to apply when transmitting the SRS. The operations of 2105 may be performed in accordance with examples as described herein. In some implementations, aspects of the operations of 2105 may be performed by a device as described with reference to FIG. 1.

FIG. 22 illustrates a flowchart of a method 2200 that supports interference measurement timing adjustment in accordance with aspects of the present disclosure. The operations of the method 2200 may be implemented by a device or its components as described herein. For example, the operations of the method 2200 may be performed by a network entity 102 as described with reference to FIGS. 1 through 10. In some implementations, the device may execute a set of instructions to control the function elements of the device to perform the described functions. Additionally, or alternatively, the device may perform aspects of the described functions using special-purpose hardware.

At 2205, the method may include transmitting, to the UE, a third signaling indicating a timing offset associated with one location region of the multiple location regions for the UE to apply when transmitting the SRS while located in the location region. The operations of 2205 may be performed in accordance with examples as described herein. In some implementations, aspects of the operations of 2205 may be performed by a device as described with reference to FIG. 1.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). By way of another example, a list of one or both of A or B means A or B or AB. Similarly, a list of at least one of A; B; or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and operable to cause the UE to:
receive an indication of a configuration of a cross-link interference (CLI) reporting that indicates one or more resources for CLI measurements;
obtain a timing offset to apply when performing the CLI measurements;
apply, while performing a CLI measurement on the one or more resources, the timing offset with respect to a reference point in time;
transmit a CLI report that includes a result of the CLI measurement.

2. The UE of claim 1, wherein the reference point is a reception time of a synchronization signal block (SSB) from a network entity.

3. The UE of claim 1, wherein the result of the CLI measurement is a sounding reference signal reference signal received power (SRS-RSRP) or a CLI received signal strength indicator (CLI-RSSI).

4. The UE of claim 1, wherein the at least one processor is further operable to cause the UE to:
obtain an estimate of a location of the UE; and
for each resource in the one or more resources:
determine a location region associated with the resource;
compute a distance between the estimate and the location region; and
compute the timing offset based on the distance.

5. The UE of claim 1, wherein the at least one processor is further operable to cause the UE to receive an indication of a new timing offset or unconfiguring the CLI reporting.

6. The UE of claim 1, wherein the timing offset is determined based at least in part on whether the UE is located in a location region, and the location region is indicated by one or more of center coordinates, a radius, or vertices of a polygon.

7. The UE of claim 1, wherein the at least one processor is further operable to cause the UE to, in response to the UE leaving a location region:
obtain an estimate of a location of the UE; and
compute, based at least in part on the location, a new timing offset to apply while performing the CLI measurement.

8. The UE of claim 1, wherein to obtain the timing offset is to receive an indication of multiple timing offsets, and the at least one processor is operable to cause the UE to:
apply the multiple timing offsets when performing the CLI measurements on the one or more resources; and
obtain multiple CLI measurement results associated with the multiple timing offsets, wherein the CLI report is based on the multiple CLI measurement results.

9. The UE of claim 8, wherein the CLI report comprises at least one of a CLI value equal to a maximum CLI measurement result of the multiple CLI measurement results, a CLI value equal to a minimum CLI measurement result of the multiple CLI measurement results, a CLI value equal to an average or a weighted average of the multiple CLI measurement results, the multiple CLI measurement results, a subset of the multiple CLI measurement results, or a sounding reference signal reference signal received power (SRS-RSRP) or a CLI received signal strength indicator (CLI-RSSI).

10. The UE of claim 1, wherein the at least one processor is further operable to cause the UE to apply the timing offset for as long as a countdown expiration timer associated with the timing offset has not reached zero.

11. The UE of claim 1, wherein the at least one processor is further operable to cause the UE to apply the timing offset for a validity duration associated with the timing offset.

12. A user equipment (UE) for wireless communication, comprising:
at least one memory; and
at least one processor coupled with the at least one memory and operable to cause the UE to:
receive an indication of a sounding reference signal (SRS) configuration for a cross-link interference (CLI) measurement;
receive an indication of a timing offset to apply when transmitting the SRS;
apply, while transmitting the SRS, the timing offset.

13. The UE of claim 12, wherein to apply the timing offset, the at least one processor is operable to cause the UE to apply the timing offset with respect to a reference point in time.

14. The UE of claim 13, wherein the reference point comprises an uplink transmission time according to an indicated timing advance (TA) or a reception time of a synchronization signal block (SSB) from a network entity.

15. The UE of claim 12, wherein the at least one processor is further operable to cause the UE to:
obtain an estimate of a location of the UE;
determine a location region based on the estimate;
determine one or more resources associated with the location region; and
transmit the SRS, according to the SRS configuration for the CLI measurement, on the one or more resources.

16. The UE of claim 12, wherein the timing offset is associated with a location region and the at least one processor is further operable to cause the UE to:
obtain an estimate of a location of the UE; and
apply, in response to determining that the location of the UE is within the location region, the timing offset while transmitting the SRS.

17. The UE of claim 12, wherein the at least one processor is further operable to cause the UE to receive an indication of a new timing offset or unconfiguring CLI reporting.

18. The UE of claim 12, wherein the at least one processor is further operable to cause the UE to:
receive a configuration for a reference signal, wherein the reference signal comprises a synchronization signal sequence, a synchronization signal identifier, or a phase rotation; and
transmit a fourth signaling in accordance with the configuration for the reference signal.

19. (canceled)

20. (canceled)

21. An apparatus for wireless communication, comprising:
at least one memory; and
at least one processor coupled with the at least one memory and operable to cause the apparatus to:
receive, from a first network entity, a first signaling indicating a configuration of one or more resources for a cross-link interference (CLI) measurement;
transmit, to a user equipment (UE), a second signaling indicating a configuration of a CLI reporting that indicates the one or more resources and a timing offset for the UE to apply when performing the CLI measurements; and
receive, from the UE, a third signaling indicating a CLI report including a result of the CLI measurements.

22. A method performed by a user equipment (UE), the method comprising:
receiving an indication of a configuration of a cross-link interference (CLI) reporting that indicates one or more resources for CLI measurements;
obtaining a timing offset to apply when performing the CLI measurements;
applying, while performing a CLI measurement on the one or more resources, the timing offset with respect to a reference point in time;
transmitting a CLI report that includes a result of the CLI measurement.
